(19) United States
(12) Patent Application Publication
(10) Pub. No.: US 2025/0006418 A1
(43) Pub. Date: Jan. 2, 2025

(54) INTEGRATED CIRCUIT, CHIP, AND TERMINAL

(71) Applicant: HUAWEI TECHNOLOGIES CO., LTD., Shenzhen (CN)

(72) Inventors: Wanyi GUO, Leuven (BE); Kefeng HAN, Shenzhen (CN); Peng GAO, Shenzhen (CN)

(21) Appl. No.: 18/886,138

(22) Filed: Sep. 16, 2024

Related U.S. Application Data
(63) Continuation of application No. PCT/CN2022/081807, filed on Mar. 18, 2022.

(51) Int. Cl. H01F 27/28; H01F 27/29

(52) U.S. Cl. CPC H01F 27/2804; H01F 27/29; H01F 2027/2809

(57) ABSTRACT

Embodiments of this application relate to an integrated circuit, a chip, and a terminal, and relate to the field of circuit technologies. An example integrated circuit includes a first inductor and a second inductor. The first inductor includes a first coil, and the first coil is a loop having a first opening. The second inductor includes a second coil and a third coil that are connected in series, and the second coil has a second opening. A magnetic field direction of the second coil is opposite to a magnetic field direction of the third coil. The second coil and the third coil are nested in the first coil, and the first inductor is not in direct contact with the second inductor.

### CROSS-REFERENCE TO RELATED APPLICATIONS

This application is a continuation of International Application No. PCT/CN2022/081807, filed on Mar. 18, 2022, the disclosure of which is hereby incorporated by reference in its entirety.

### TECHNICAL FIELD

This application relates to the field of circuit technologies, and in particular, to an integrated circuit, a chip, and a terminal.

### BACKGROUND

An inductor is one of basic components commonly used in an integrated circuit, and may be used in various circuits. For example, the inductor may be used in a power divider/combiner, or two mutually-coupled inductors may be used, in a form of a transformer, in a single-frequency bidirectional amplifier. Therefore, performance of a plurality of circuits can be improved by flexibly designing one or more inductors.

### SUMMARY

To resolve the foregoing technical problem, this application provides an integrated circuit, a chip, and a terminal, to reduce layout areas occupied by a first inductor and a second inductor in the integrated circuit, thereby reducing a layout area occupied by the integrated circuit.

According to a first aspect, this application provides an integrated circuit, where the integrated circuit includes a first inductor and a second inductor. The first inductor includes a first coil, and the first coil is a loop having a first opening. The second inductor includes a second coil and a third coil that are connected in series, and the second coil has a second opening. A magnetic field direction of the second coil is opposite to a magnetic field direction of the third coil. The second coil and the third coil are nested in the first coil, and the first inductor is not in direct contact with the second inductor.

The second coil and the third coil are nested in the first coil, so that layout areas occupied by the second coil and the third coil can be omitted. In other words, a total area occupied by the first coil, the second coil, and the third coil is an area occupied by the first coil. Therefore, a total area of the first inductor and the second inductor is reduced. In comparison with a case in which the first inductor and the second inductor are separately disposed, the total area of the first inductor and the second inductor may be reduced by about 50%, thereby reducing costs of the chip.

In some possible implementations, a magnitude of magnetic flux in a first subloop is equal to a magnitude of magnetic flux in a second subloop, and magnetic flux flowing through the first subloop and magnetic flux flowing through the second subloop cancel with each other. Therefore, for the first coil nested outside the second coil and the third coil, a sum of the magnetic flux in the second coil and in the third coil is 0, and the second inductor is not coupled to the first inductor.

In some other possible implementations, a magnitude of magnetic flux in a first subloop is not equal to a magnitude of magnetic flux in a second subloop, and magnetic flux flowing through the first subloop and magnetic flux flowing through the second subloop partially cancel with each other, to adapt to a required application scenario.

In some embodiments, when the magnitude of the magnetic flux in the first subloop is not equal to the magnitude of the magnetic flux in the second subloop, the second inductor may further include a fourth coil connected in series to the second coil and the third coil, and the fourth coil is nested in the first coil. A magnetic field direction of the fourth coil is the same as the magnetic field direction of the second coil. A magnitude of magnetic flux in the third coil is equal to a magnitude of magnetic flux in the second coil and in the fourth coil. Magnetic flux flowing through the third coil and magnetic flux flowing through the second coil and the fourth coil cancel with each other. Therefore, for the first coil nested outside the second coil, the third coil, and the fourth coil, a sum of magnetic flux in the second coil, in the third coil, and in the fourth coil is 0, and the second inductor is not coupled to the first inductor.

Certainly, the magnitude of the magnetic flux in the third coil may alternatively be different from the magnitude of the magnetic flux in the second coil and in the fourth coil, to adapt to a required application scenario. The second inductor may further include more coils that are connected in series to the second coil, the third coil, and the fourth coil. This is not limited in embodiments of this application.

In some possible implementations, the second coil includes a first bent portion and a first subloop, the third coil includes a second bent portion and a second subloop, and the first bent portion coincides with the second bent portion. The first inductor further includes a first lead electrically connected to an input end and an output end of the first coil at the first opening, and the second inductor further includes a second lead electrically connected to an input end and an output end of the second coil at the second opening. Positions for disposing the first inductor and the second inductor in the chip may include, for example, the following several cases.

In a first case, regardless of whether the first inductor coincides with the second lead, the first coil and the first lead of the first inductor and the second bent portion of the second inductor are all disposed at a first layer. The first subloop of the second inductor, the second subloop, and the first bent portion are all disposed at a second layer. In addition, orthographic projections of the second coil and the third coil on a substrate are located within a range of orthographic projection of the first coil on the substrate, so that the second coil and the third coil are nested in the first coil. In this way, the first inductor and the second inductor can be implemented by using only two conducting layers. In addition, the first inductor may not be in direct contact with the second inductor, so that the first bent portion is not in direct contact with the second bent portion, and this avoids a case in which the first subloop and the second subloop are short-circuited.

In a second case, if the first inductor does not coincide with the second lead, the first coil and the first lead of the first inductor, and the second lead, the first bent portion, the first subloop, and the second subloop of the second inductor are disposed at a same layer. The second bent portion of the second inductor is disposed at a separate layer. In addition, orthographic projections of the second coil and the third coil on a substrate are located within a range of orthographic projection of the first coil on the substrate, so that the second coil and the third coil are nested in the first coil. In this way, the first inductor and the second inductor can be implemented by using only two conducting layers. In addition, the first inductor may not be in direct contact with the second inductor, so that the first bent portion is not in direct contact with the second bent portion, and this avoids a case in which the first subloop and the second subloop are short-circuited.

In a third case, if the first inductor at least partially coincides with the second lead, the first coil and the first lead of the first inductor and the first bent portion, the first subloop, and the second subloop of the second inductor are disposed at a same layer. The second bent portion of the second inductor and the second lead are disposed at a same layer. In addition, orthographic projections of the second coil and the third coil on a substrate are located within a range of orthographic projection of the first coil on the substrate, so that the second coil and the third coil are nested in the first coil. In this way, the first inductor and the second inductor can be implemented by using only two conducting layers. In addition, the first inductor may not be in direct contact with the second inductor, so that the first bent portion is not in direct contact with the second bent portion, and this avoids a case in which the first subloop and the second subloop are short-circuited.

In a fourth case, the first coil and the first lead of the first inductor are both disposed at a first layer. The first subloop, the second subloop, and the first bent portion of the second inductor are all disposed at the second layer, and the second bent portion of the second inductor is disposed at the third layer. In addition, orthographic projections of the second coil and the third coil on a substrate are located within a range of orthographic projection of the first coil on the substrate. In this way, the first inductor and the second inductor may be implemented by using three conducting layers. In addition, the first inductor may not be in direct contact with the second inductor, so that the first bent portion is not in direct contact with the second bent portion, and this avoids a case in which the first subloop and the second subloop are short-circuited.

Certainly, the first inductor and the second inductor may also be implemented by using more conducting layers or in another combination manner. A case is met that the first inductor and the second inductor are not in direct contact, and the first bent portion and the second bent portion are not in direct contact. Other forms made by a person skilled in the art under teachings of this application also fall within the protection of this application.

In some possible implementations, the foregoing first inductor and the second inductor that are not coupled to each other and that can reduce a chip layout area may be used in the foregoing circuits such as a single-frequency single-ended power divider/combiner, a dual-frequency single-ended power divider/combiner, a single-frequency single-ended single-pole double-throw switch, and a dual-frequency single-ended single-pole double-throw switch.

In a possible implementation, that the first inductor and the second inductor are used in the single-frequency single-ended power divider/combiner is used as an example. The integrated circuit further includes a first input end, a first output end, and a second output end. The first inductor is electrically connected between the first input end and the first output end, and the second inductor is electrically connected between the first input end and the second output end.

Both branches of the single-frequency single-ended power divider/combiner include an inductor, and the inductors on the two branches are not coupled to each other. The first inductor and the second inductor in embodiments of this application can meet the foregoing requirements. In addition, because a total area occupied by the first coil, the second coil, and the third coil (or the first coil, the second coil, the third coil, and the fourth coil) is an area occupied by the first coil, by using the first inductor and the second inductor as the two inductors of the single-frequency single-ended power divider/combiner, a layout area occupied by the single-frequency single-ended power divider/combiner can be reduced while ensuring normal operation of the single-frequency single-ended power divider/combiner. In comparison with a related technology, the layout area occupied by the single-frequency single-ended power divider/combiner can be reduced by about 50%, so that a layout area of a chip is reduced, and costs of the chip are reduced.

In another possible implementation, that the first inductor and the second inductor are used in the single-frequency single-ended single-pole double-throw switch is used as an example. In addition to the first input end, the first output end, and the second output end, the integrated circuit further includes a first switch and a second switch. One end of the first switch is electrically connected between the first inductor and the first output end, and the other end is grounded. One end of the second switch is electrically connected between the second inductor and the second output end, and the other end is grounded.

Both branches of the single-frequency single-ended single-pole double-throw switch include an inductor, and the inductors on the two branches are not coupled to each other. The first inductor and the second inductor in embodiments of this application can meet the foregoing requirements. In addition, because a total area occupied by the first coil, the second coil, and the third coil (or the first coil, the second coil, the third coil, and the fourth coil) is an area occupied by the first coil, by using the first inductor and the second inductor as the two inductors of the single-frequency single-ended single-pole double-throw switch, a layout area occupied by the single-frequency single-ended single-pole double-throw switch can be reduced while ensuring normal operation of the single-frequency single-ended single-pole double-throw switch. In comparison with a related technology, the layout area occupied by the single-frequency single-ended single-pole double-throw switch may be reduced by about 50%, so that a layout area of a chip is reduced, and costs of the chip are reduced.

In still another possible implementation, for example, the first inductor and the second inductor are used in the dual-frequency single-ended power divider/combiner, and there are two first inductors and two second inductors. The integrated circuit includes a second input end, a third input end, a third output end, a fourth output end, a fifth output end, and a sixth output end. One first inductor is electrically connected between the second input end and the third output end, and the other first inductor is electrically connected between the second input end and the fifth output end. One second inductor is electrically connected between the third input end and the fourth output end, and the other second inductor is electrically connected between the third input end and the sixth output end.

The first inductor in one inductor combination is electrically connected between the second input end and the third output end, the second inductor in one inductor combination is electrically connected between the third input end and a fourth output end, the first inductor in another inductor combination is electrically connected between the second input end and the fifth output end, and the second inductor in the another inductor combination is electrically connected between the third input end and the sixth output end, so that it can be ensured that the dual-frequency single-ended power divider/combiner operates normally, and a layout area occupied by the dual-frequency single-ended power divider/combiner is reduced. In comparison with a related technology, the layout area occupied by the dual-frequency single-ended power divider/combiner may be reduced by about 50%, so that a layout area of a chip is reduced, and costs of the chip are reduced.

In still another possible implementation, that the first inductor and the second inductor are used in the dual-frequency single-ended single-pole double-throw switch is used as an example. In addition to the two first inductors, the two second inductors, the second input end, the third input end, the third output end, the fourth output end, the fifth output end, and the sixth output end, the integrated circuit further includes a third switch, a fourth switch, a fifth switch, and a sixth switch. One end of the third switch is electrically connected between the one first inductor and the third output end, and the other end is grounded. One end of the fourth switch is electrically connected between the one second inductor and the fourth output end, and the other end is grounded. One end of fifth switch is electrically connected between the other first inductor and fifth output end, and the other end is grounded. One end of sixth switch is electrically connected between the other second inductor and sixth output end, and the other end is grounded.

The first inductor in one inductor combination is electrically connected between the second input end and the third output end, the second inductor in one inductor combination is electrically connected between the third input end and a fourth output end, the first inductor in another inductor combination is electrically connected between the second input end and the fifth output end, and the second inductor in the another inductor combination is electrically connected between the third input end and the sixth output end, so that it can be ensured that the dual-frequency single-ended power divider/combiner operates normally, and a layout area occupied by the dual-frequency single-ended power divider/combiner is reduced. In comparison with a related technology, the layout area occupied by the dual-frequency single-ended power divider/combiner may be reduced by about 50%, so that a layout area of a chip is reduced, and costs of the chip are reduced.

In some possible implementations, in addition to the first inductor and the second inductor, the integrated circuit further includes a third inductor and a fourth inductor. The third inductor includes a fifth coil, and the fifth coil is a loop having a third opening.

The fourth inductor includes a sixth coil and a seventh coil that are connected in series. The sixth coil has a fourth opening, and a magnetic field direction of the sixth coil is opposite to a magnetic field direction of the seventh coil. The fifth coil is nested in the first coil. The third coil, the fourth coil, the sixth coil, and the seventh coil are nested in the fifth coil. The first inductor, the second inductor, the third inductor, and the fourth inductor are not in direct contact.

The fifth coil is nested in the first coil. The second coil, the third coil, the sixth coil, and the seventh coil are nested in the fifth coil, so that layout areas occupied by the second coil, the third coil, the fifth coil, the sixth coil, and the seventh coil can be omitted. In other words, a total area occupied by the first coil, the second coil, the third coil, the fifth coil, the sixth coil, and the seventh coil is an area occupied by the first coil. Therefore, a total area of the first inductor, the second inductor, the third inductor, and the fourth inductor is reduced. In comparison with a case in which two transformers are separately disposed, a total area of two transformers including the first inductor and the third inductor, and the second inductor and the fourth inductor may be reduced by about 50%, thereby reducing costs of the chip.

In addition, for the first inductor and the third inductor, the first inductor and the third inductor may be coupled to each other, and the first inductor and the third inductor may form a transformer. For the second inductor and the fourth inductor, the second inductor and the fourth inductor may be coupled to each other, and the second inductor and the fourth inductor may form a transformer.

When the integrated circuit includes the third inductor and the fourth inductor, the sixth coil includes a third bent portion and a third subloop, the seventh coil includes a fourth bent portion and a fourth subloop, and the third bent portion coincides with the fourth bent portion. The third inductor further includes a third lead, and an input end and an output end of the fifth coil are electrically connected to the third lead at the third opening. The fourth inductor further includes a fourth lead, and an input end and an output end of the sixth coil are electrically connected to the fourth lead at the fourth opening.

When the second coil and the fourth coil are staggered, so that the first bent portion and the second bent portion are staggered with the third bent portion and the fourth bent portion respectively, if the first lead does not coincide with the fourth lead, and the second lead does not coincide with the third lead, the first coil and the first lead of the first inductor, the second bent portion, the fifth coil, the third subloop, the fourth subloop, the fourth bent portion, and the fourth lead are disposed at a same layer. The first subloop, the second subloop, the first bent portion, the second lead, the third lead, and the third bent portion are disposed at a same layer. In addition, orthographic projections of the second coil, the third coil, the sixth coil, and the seventh coil on a substrate are located within a range of orthographic projections of the fifth coil on the substrate. An orthographic projection of the fifth coil on the substrate is located within a range of an orthographic projection of the first coil on the substrate. In this way, the first inductor, the second inductor, the third inductor, and the fourth inductor can be implemented by using only two conducting layers.

Certainly, other solutions in which the first inductor, the second inductor, the third inductor, and the fourth inductor may be implemented by using two or more conducting layers all fall within the protection of this application.

In some possible implementations, a signal is sent to the fourth inductor through one end of the fourth lead, and the fourth inductor may generate magnetic flux. According to a right-hand rule, directions of magnetic flux in the third subloop and the fourth subloop are opposite.

In some possible implementations, a magnitude of magnetic flux in the third subloop is equal to a magnitude of magnetic flux in the fourth subloop, and magnetic flux flowing through the third subloop and the fourth subloop cancel with each other. Therefore, for the first coil and the fifth coil that are nested outside the sixth coil and the seventh coil, a sum of magnetic flux on the sixth coil and the seventh coil is 0, and the second inductor is not coupled to the first inductor and the third inductor.

In some other possible implementations, a magnitude of magnetic flux in the third subloop is not equal to a magnitude of magnetic flux in the fourth subloop, and magnetic flux flowing through the third subloop and magnetic flux flowing through the fourth subloop partially cancel with each other, to adapt to a required application scenario.

In some embodiments, when a magnitude of magnetic flux in the third subloop is not equal to a magnitude of magnetic flux in the fourth subloop, the second inductor may further include an eighth coil connected in series to the sixth coil and the seventh coil, and the eighth coil is nested in the fifth coil. A magnetic field direction of the eighth coil is the same as a magnetic field direction of the sixth coil. A magnitude of magnetic flux in the seventh coil is equal to a magnitude of magnetic flux in the sixth coil and the eighth coil. Magnetic flux flowing through the seventh coil and magnetic flux flowing through the sixth coil and the eighth coil cancel with each other. Therefore, for the fifth coil and the first coil that are nested outside the sixth coil, the seventh coil, and the eighth coil, a sum of magnetic flux on the sixth coil, the seventh coil, and the eighth coil is 0, and the fourth inductor is not coupled to the first inductor and the third inductor.

Certainly, the magnitude of the magnetic flux in the seventh coil may alternatively be different from the magnitude of the magnetic flux in the sixth coil and the eighth coil, to adapt to a required application scenario. The fourth inductor may further include more coils that are connected in series to the sixth coil, the seventh coil, and the eighth coil. This is not limited in embodiments of this application.

In addition, when the fourth inductor includes the sixth coil, the seventh coil, the eighth coil, or even more coils, for positions for disposing the first inductor, the second inductor, the third inductor, and the fourth inductor in the chip, refer to the foregoing description that the fourth inductor includes the sixth coil and the seventh coil. Fewer layers of conducting layers occupied by the first inductor, the second inductor, the third inductor, and the fourth inductor are preferred.

In some possible implementations, the first inductor, the second inductor, the third inductor, and the fourth inductor may be used in circuits such as a single-frequency differential power divider/combiner, a dual-frequency differential power divider/combiner, a single-frequency differential single-pole double-throw switch, and a dual-frequency differential single-pole double-throw switch.

In a possible implementation, that the first inductor, the second inductor, the third inductor, and the fourth inductor are used in the single-frequency differential power divider/combiner is used as an example. In addition to the first inductor, the second inductor, the third inductor, and the fourth inductor, the integrated circuit includes a fourth input end, a fifth input end, a seventh output end, an eighth output end, a ninth output end, and a tenth output end. The first inductor is electrically connected between the fourth input end and the seventh output end. The second inductor is electrically connected between the fifth input end and the eighth output end. The third inductor is electrically connected between the fourth input end and the ninth output end. The fourth inductor is electrically connected between the fifth input end and the tenth output end.

The first inductor, the second inductor, the third inductor, and the fourth inductor in embodiments of this application may meet the foregoing requirements. In addition, a total area occupied by the first coil, the second coil, the third coil, the fifth coil, the sixth coil, and the seventh coil is an area occupied by the first coil. Therefore, the first inductor and the third inductor are used as two inductors of one single-frequency single-ended power divider/combiner, and the second inductor and the fourth inductor are used as two inductors of another single-frequency single-ended power divider/combiner. The first inductor and the second inductor are not coupled to each other, the third inductor and the fourth inductor are not coupled to each other, the first inductor and the third inductor are coupled to each other, and the second inductor and the fourth inductor are coupled to each other. In this way, a layout area occupied by the single-frequency differential power divider/combiner can be reduced while ensuring normal operation of the single-frequency differential power divider/combiner. In comparison with another single-frequency differential power divider/combiner, a layout area of the single-frequency differential power divider/combiner in this application may be reduced by about 50%, thereby reducing a layout area of a chip and reducing costs of the chip.

In another possible implementation, that the first inductor, the second inductor, the third inductor, and the fourth inductor are used in the single-frequency differential single-pole double-throw switch is used as an example. In addition to the first inductor, the second inductor, the third inductor, the fourth inductor, the fourth input end, the fifth input end, the seventh output end, the eighth output end, the ninth output end, and the tenth output end, the integrated circuit further includes a seventh switch and an eighth switch. One end of the seventh switch is electrically connected between the first inductor and the seventh output end, and the other end is electrically connected between the second inductor and the eighth output end. One end of the eighth switch is electrically connected between the third inductor and the ninth output end, and the other end is electrically connected between the fourth inductor and the tenth output end.

In this application, the seventh switch and the eighth switch are controlled to be open or closed, so that whether the two single-frequency single-ended power divider/combiners in the single-frequency differential power divider/combiners operate can be controlled, to implement signal transmission in different scenarios.

In still another possible implementation, that the first inductor, the second inductor, the third inductor, and the fourth inductor are used in the dual-frequency differential power divider/combiner is used as an example. There are two first inductors, two second inductors, two third inductors, and two fourth inductors in the integrated circuit. On this basis, the integrated circuit further includes a sixth input end, a seventh input end, an eighth input end, a ninth input end, an eleventh output end, a twelfth output end, a thirteenth output end, a fourteenth output end, a fifteenth output end, a sixteenth output end, a seventeenth output end, and an eighteenth output end. One first inductor is electrically connected between the sixth input end and the eleventh output end, and the other first inductor is electrically connected between the sixth input end and the fifteenth output end. One second inductor is electrically connected between the seventh input end and the twelfth output end, and the other second inductor is electrically connected between the seventh input end and the sixteenth output end. One third inductor is electrically connected between the eighth input end and the thirteenth output end, and the other third inductor is electrically connected between the eighth input end and the seventeenth output end. One fourth inductor is electrically connected between the ninth input end and the fourteenth output end, and the other fourth inductor is electrically connected between the ninth input end and the eighteenth output end.

Embodiments of this application may provide two inductor combinations. Each inductor combination includes one first inductor, one second inductor, one third inductor, and one fourth inductor. In addition, a total area occupied by the first coil, the second coil, the third coil, the fifth coil, the sixth coil, and the seventh coil is an area occupied by the first coil. Therefore, the two first inductors, the two second inductors, the two third inductors, and the two fourth inductors in the two inductor combinations are used as inductors on eight branches of the dual-frequency differential power divider/combiner. In a case in which normal operation of the dual-frequency differential power divider/combiner is ensured, a layout area occupied by the dual-frequency differential power divider/combiner can be reduced, thereby reducing a layout area of the chip and reducing costs of the chip.

In still another possible implementation, that the first inductor, the second inductor, the third inductor, and the fourth inductor are used in the dual-frequency differential single-pole double-throw switch is used as an example. In addition to the first inductor, the second inductor, the third inductor, the fourth inductor, the sixth input end, the seventh input end, the eighth input end, the ninth input end, the eleventh output end, the twelfth output end, the thirteenth output end, the fourteenth output end, the fifteenth output end, the sixteenth output end, the seventeenth output end, and the eighteenth output end, the integrated circuit further includes a ninth switch, a tenth switch, an eleventh switch, and a twelfth switch. One end of the ninth switch is electrically connected between the one first inductor and the eleventh output end, and the other end is electrically connected between the one third inductor and the thirteenth output end. One end of the tenth switch is electrically connected between the one second inductor and the twelfth output end, and the other end is electrically connected between the one fourth inductor and the fourteenth output end. One end of the eleventh switch is electrically connected between the other first inductor and the fifteenth output end, and the other end is electrically connected between the other third inductor and the seventeenth output end. One end of the twelfth switch is electrically connected between the other second inductor and the sixteenth output end, and the other end is electrically connected between the other fourth inductor and the eighteenth output end.

In this application, the ninth switch, the tenth switch, the eleventh switch, and the twelfth switch are controlled to be open or closed, to control whether two pairs of single-frequency differential power divider/combiners in the dual-frequency differential power divider/combiners operate, to implement signal transmission in different scenarios.

In still another possible implementation, that the first inductor, the second inductor, the third inductor, and the fourth inductor are used in the dual-frequency amplifier is used as an example. The dual-frequency amplifier includes a first amplifier, a second amplifier, a first sub-transformer, a second sub-transformer, a third sub-transformer, and a fourth sub-transformer. Input ends of the first amplifier and the second amplifier are electrically connected to the first sub-transformer and the second sub-transformer, and output ends of the first amplifier and the second amplifier are electrically connected to the third sub-transformer and the fourth sub-transformer. The first sub-transformer includes a first inductor and a third inductor, the second sub-transformer includes a second inductor and a fourth inductor, the third sub-transformer includes another first inductor and another third inductor, and the fourth sub-transformer includes another second inductor and another fourth inductor. On this basis, the integrated circuit may further include two thirteenth switches, two fifteenth switches, and two sixteenth switches. One thirteenth switch is electrically connected between the first inductor and the second inductor on an input side, and the other thirteenth switch is electrically connected between the first inductor and the second inductor on an output side. One fifteenth switch and one sixteenth switch are electrically connected between the third inductor and the fourth inductor on the input side respectively, and the other fifteenth switch and the other sixteenth switch are electrically connected between the third inductor and the fourth inductor on the output side respectively.

In embodiments of this application, in comparison with a dual-frequency amplifier proposed in the related technology, in this application, the two thirteenth switches, the two fifteenth switches, and the two sixteenth switches are added to adjust a gain of the dual-frequency amplifier, so that the dual-frequency amplifier does not need to rely on an active circuit to perform gain switching. This avoids increasing design costs and power consumption of a chip due to the active circuit. In addition, the first sub-transformer, the second sub-transformer, the third sub-transformer, and the fourth sub-transformer in this application may be further used to reduce layout areas occupied by four transformers.

In still another possible implementation, that the first inductor, the second inductor, the third inductor, and the fourth inductor are used in a single-frequency bidirectional amplifier is used as an example. The single-frequency bidirectional amplifier further includes a first end, a second end, a third amplifier and a fourth amplifier that are inverted, a first sub-transformer, a second sub-transformer, a third sub-transformer, a fourth sub-transformer, two first inductors, two second inductors, a seventeenth switch, an eighteenth switch, a nineteenth switch, a twentieth switch, two fifteenth switches, and two sixteenth switches. The third amplifier and the fourth amplifier are electrically connected between the first end and the second end. The first sub-transformer and the second sub-transformer are electrically connected between the first end, and the third amplifier and the fourth amplifier. The third sub-transformer and the fourth sub-transformer are electrically connected between the second end, and the third amplifier and the fourth amplifier. One end of the seventeenth switch is electrically connected between the first end and the first inductor of the first sub-transformer, and the other end is grounded. One end of the eighteenth switch is electrically connected between the first end and the second inductor of the second sub-transformer, and the other end is grounded. One end of the nineteenth switch is electrically connected between the second end and the first inductor of the third sub-transformer, and the other end is grounded. One end of the twentieth switch is electrically connected between the second end and the second inductor of the fourth sub-transformer, and the other end is grounded. One first inductor is electrically connected between the first end and the seventeenth switch, and the other first inductor is electrically connected between the second end and the nineteenth switch. One second inductor is electrically connected between the first end and the eighteenth switch, and the other second inductor is electrically connected between the second end and the twentieth switch. One fifteenth switch and one sixteenth switch are electrically connected between the third inductor of the first sub-transformer and the fourth inductor of the second sub-transformer, and the other fifteenth switch and the other sixteenth switch are electrically connected between the third inductor of the third sub-transformer and the fourth inductor of the fourth sub-transformer.

In embodiments of this application, in comparison with the single-frequency bidirectional amplifier proposed in the related technology, in this application, the two fifteenth switches and the two sixteenth switches are added to adjust a gain of the single-frequency bidirectional amplifier, so that the single-frequency bidirectional amplifier does not need to rely on an active circuit to perform gain switching. This avoids increasing design costs and power consumption of a chip due to the active circuit. In addition, the first sub-transformer, the second sub-transformer, the third sub-transformer, and the fourth sub-transformer in this application may be further used to reduce layout areas occupied by four transformers. The two first inductors and the two second inductors are used to reduce layout areas occupied by four inductors.

In some possible implementations, the second coil may further coincide with the sixth coil, and the third coil may further coincide with the seventh coil, to reduce a total area occupied by the second coil, the third coil, the sixth coil, and the seventh coil. When layout areas occupied by the second coil, the third coil, the sixth coil, and the seventh coil remain unchanged, layout areas occupied by the first coil and the fifth coil may be reduced, thereby reducing a layout area of the integrated circuit.

In some possible implementations, the first inductor and the third inductor are spiral inductors, and the first coil and the fifth coil include a plurality of loops. In comparison with an ordinary inductor, the spiral inductor can improve performance of the integrated circuit.

According to a second aspect, this application provides an integrated circuit. The integrated circuit includes a first transformer, a second transformer, a first switch, a second switch, a third switch, and a fourth switch. The first transformer includes a first inductor and a third inductor, where the first inductor and the third inductor are coupled to each other. The second transformer includes a second inductor and a fourth inductor, where the second inductor and the fourth inductor are coupled to each other. The first inductor is connected in parallel to the second inductor through the first switch and the second switch, and the third inductor is connected in parallel to the fourth inductor through the third switch and the fourth switch.

In addition, the first inductor is not coupled to the second inductor and the fourth inductor, and the third inductor is not coupled to the second inductor and the fourth inductor.

The first switch is electrically connected between an input end of the first inductor and an input end of the second inductor, and the second switch is electrically connected between an output end of the first inductor and an output end of the second inductor. The third switch is electrically connected between an input end of the third inductor and an input end of the fourth inductor, and the fourth switch is electrically connected between an output end of the third inductor and an output end of the fourth inductor.

When the first transformer and the second transformer including the first inductor, the second inductor, the third inductor, and the fourth inductor are used in an actual circuit, a gain of the circuit including the first inductor, the second inductor, the third inductor, and the fourth inductor may be adjusted by closing or opening any one of the first switch, the second switch, the third switch, and the fourth switch.

In some possible implementations, the first inductor includes a first coil, and the first coil is a loop having a first opening. The second inductor includes a second coil and a third coil that are connected in series. The second coil has a second opening. A magnetic field direction of the second coil is opposite to a magnetic field direction of the third coil. The third inductor includes a fifth coil, and the fifth coil is a loop having a third opening. The fourth inductor includes a sixth coil and a seventh coil that are connected in series. The sixth coil has a fourth opening. A magnetic field direction of the sixth coil is opposite to a magnetic field direction of the seventh coil. The fifth coil is nested in the first coil. The second coil, the third coil, the sixth coil, and the seventh coil are nested in the fifth coil. The first inductor, the second inductor, the third inductor, and the fourth inductor are not in direct contact.

In some possible implementations, the second inductor further includes a fourth coil connected in series to the second coil and the third coil. A magnetic field direction of the fourth coil is the same as a magnetic field direction of the second coil. A magnitude of magnetic flux in the third coil is equal to a magnitude of magnetic flux in the second coil and the fourth coil. The fourth coil is nested in the first coil. The fourth inductor further includes an eighth coil connected in series to the sixth coil and the seventh coil. A magnetic field direction of the eighth coil is the same as a magnetic field direction of the sixth coil. A magnitude of magnetic flux in the seventh coil is equal to a magnitude of magnetic flux in the sixth coil and the eighth coil. The eighth coil is nested in the fifth coil.

In some possible implementations, a magnitude of magnetic flux in the third coil is equal to a magnitude of magnetic flux in the second coil, and a magnitude of magnetic flux in the seventh coil is equal to a magnitude of magnetic flux in the sixth coil. The second coil includes a first bent portion and a first subloop. The third coil includes a second bent portion and a second subloop. The first bent portion coincides with the second bent portion. The sixth coil includes a third bent portion and a third subloop. The seventh coil includes a fourth bent portion and a fourth subloop. The third bent portion coincides with the fourth bent portion. The first bent portion and the second bent portion are respectively disposed in a staggered manner with the third bent portion and the fourth bent portion. The first inductor further includes a first lead electrically connected to the first coil at the first opening. The second inductor further includes a second lead electrically connected to the second coil at the second opening. The third inductor further includes a third lead electrically connected to the fifth coil at the third opening. The fourth inductor further includes a fourth lead electrically connected to the sixth coil at the fourth opening. The first lead does not coincide with the fourth lead, and the second lead does not coincide with the third lead. The first inductor, the second bent portion, the fifth coil, the third subloop, the fourth subloop, the fourth bent portion, and the fourth lead are disposed at a same layer. The first subloop, the second subloop, the first bent portion, the second lead, the third lead, and the third bent portion are disposed at a same layer.

An implementation of the second aspect corresponds to any implementation of the first aspect. For technical effects corresponding to the implementations of the second aspect, refer to technical effects corresponding to the first aspect and any implementation of the first aspect. Details are not described herein again.

According to a third aspect, this application further provides a chip, where the chip includes a circuit board and the integrated circuit according to the first aspect or the second aspect, and the integrated circuit is disposed on the circuit board.

An implementation of the third aspect corresponds to any implementation of the first aspect. For technical effects corresponding to the implementations of the third aspect, refer to the technical effects corresponding to the first aspect, the second aspect, and any one of the implementations of the first aspect and the second aspect. Details are not described herein again.

According to a fourth aspect, this application further provides a terminal, where the terminal includes the chip according to the third aspect.

An implementation of the fourth aspect corresponds to any one of the implementations of the first aspect or the second aspect. For technical effects corresponding to the implementations of the fourth aspect, refer to the technical effects corresponding to the first aspect, the second aspect, and any one of the implementations of the first aspect and the second aspect. Details are not described herein again.

### BRIEF DESCRIPTION OF DRAWINGS

FIG. 1 is a diagram of an architecture of a time division duplexing phased array system according to an embodiment of this application;

FIG. 2a is a circuit diagram of a single-frequency single-ended power divider/combiner according to a related technology;

FIG. 2b is a circuit diagram of a dual-frequency single-ended power divider/combiner according to a related technology;

FIG. 2c is a circuit diagram of a single-frequency single-ended single-pole double-throw switch according to a related technology;

FIG. 2d is a circuit diagram of a dual-frequency single-ended single-pole double-throw switch according to a related technology;

FIG. 2e is a circuit diagram of a dual-frequency amplifier according to a related technology;

FIG. 2f is a circuit diagram of a single-frequency bidirectional amplifier according to a related technology;

FIG. 3a is a diagram of a position relationship between a first inductor and a second inductor according to an embodiment of this application;

FIG. 3b is a diagram of another position relationship between a first inductor and a second inductor according to an embodiment of this application;

FIG. 3c is a diagram of another position relationship between a first inductor and a second inductor according to an embodiment of this application;

FIG. 3d is a diagram of another position relationship between a first inductor and a second inductor according to an embodiment of this application;

FIG. 3e is a diagram of another position relationship between a first inductor and a second inductor according to an embodiment of this application;

FIG. 4a is a diagram of another position relationship between a first inductor and a second inductor according to an embodiment of this application;

FIG. 4b is a diagram of another position relationship between a first inductor and a second inductor according to an embodiment of this application;

FIG. 4c is a diagram of another position relationship between a first inductor and a second inductor according to an embodiment of this application;

FIG. 5a is a diagram of a coupling relationship between a first inductor and a second inductor according to an embodiment of this application;

FIG. 5b is a diagram of another position relationship between a first inductor and a second inductor according to an embodiment of this application;

FIG. 6a is a circuit diagram of a single-frequency single-ended power divider/combiner according to an embodiment of this application;

FIG. 6b is a circuit diagram of a single-frequency single-ended single-pole double-throw switch according to an embodiment of this application;

FIG. 7a is a circuit diagram of a dual-frequency single-ended power divider/combiner according to an embodiment of this application;

FIG. 7b is a circuit diagram of a dual-frequency single-ended single-pole double-throw switch according to an embodiment of this application;

FIG. 8a is a diagram of a position relationship between a first inductor, a second inductor, a third inductor, and a fourth inductor according to an embodiment of this application;

FIG. 8b is a diagram of another position relationship between a first inductor, a second inductor, a third inductor, and a fourth inductor according to an embodiment of this application;

FIG. 8c is a diagram of still another position relationship between a first inductor, a second inductor, a third inductor, and a fourth inductor according to an embodiment of this application;

FIG. 8d is a diagram of yet another position relationship between a first inductor, a second inductor, a third inductor, and a fourth inductor according to an embodiment of this application;

FIG. 9 is a diagram of a coupling relationship between a first inductor, a second inductor, a third inductor, and a fourth inductor according to an embodiment of this application;

FIG. 10a is a circuit diagram of a single-frequency differential power divider/combiner according to an embodiment of this application;

FIG. 10b is a circuit diagram of a single-frequency differential single-pole double-throw switch according to an embodiment of this application;

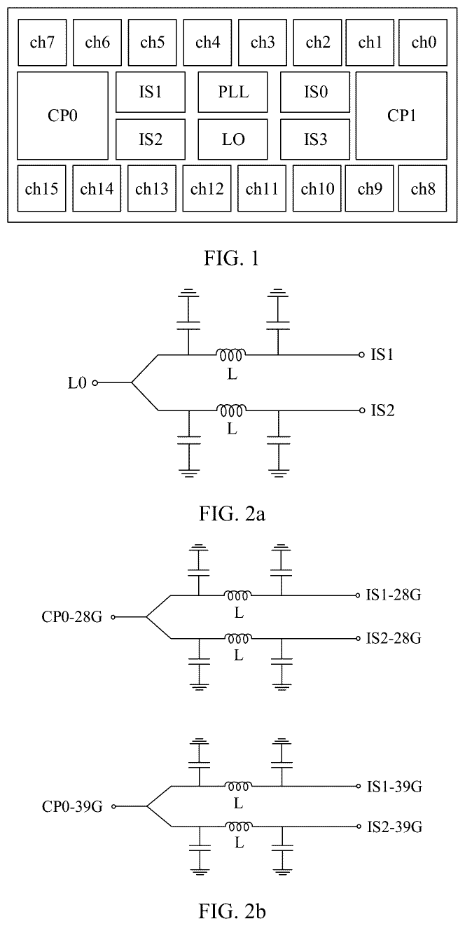

FIG. 1la is a circuit diagram of a dual-frequency differential power divider/combiner according to an embodiment of this application;

FIG. 11b is a circuit diagram of a dual-frequency differential single-pole double-throw switch according to an embodiment of this application;

FIG. 12a is a diagram of a connection relationship between components in an integrated circuit according to an embodiment of this application;

FIG. 12b is a diagram of a coupling relationship between components in an integrated circuit according to an embodiment of this application;

FIG. 13a is an equivalent circuit diagram of the integrated circuit in FIG. 12a;

FIG. 13b is another equivalent circuit diagram of the integrated circuit in FIG. 12a;

FIG. 13c is still another equivalent circuit diagram of the integrated circuit in FIG. 12a;

FIG. 13d is yet another equivalent circuit diagram of the integrated circuit in FIG. 12a;

FIG. 14 is a circuit diagram of a dual-frequency amplifier according to an embodiment of this application;

FIG. 15a is a circuit diagram of a single-frequency bidirectional amplifier according to an embodiment of this application;

FIG. 15b is an equivalent circuit diagram of the single-frequency bidirectional amplifier in FIG. 15a; and

FIG. 15c is another equivalent circuit diagram of the single-frequency bidirectional amplifier in FIG. 15a.

### DESCRIPTION OF EMBODIMENTS

The following clearly and completely describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application without creative efforts shall fall within the protection scope of this application.

The term “and/or” in this specification describes only an association relationship for describing associated objects and represents that three relationships may exist. For example, A and/or B may represent the following three cases: Only A exists, both A and B exist, and only B exists.

In the specification and claims in embodiments of this application, the terms “first”, “second”, and so on are intended to distinguish between different objects but do not indicate a particular order of the objects. For example, a first target object, a second target object, and the like are used for distinguishing between different target objects, but are not used for describing a specific order of the target objects.

In addition, in embodiments of this application, the word “exemplary” or “for example” is used to represent giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a related concept in a specific manner.

In the description of the embodiment of this application, unless otherwise stated, “multiple” means two or more than two. For example, a plurality of processing units mean two or more processing units, and a plurality of systems mean two or more systems.

Embodiments of this application provide a terminal. The terminal may be a device that includes a chip and that integrates an inductor or a transformer in the chip, such as a mobile phone, a computer, a tablet computer, a television, an in-vehicle display, a smartwatch, a server, a memory, a radar, a base station, or an optical transceiver. Certainly, the terminal may alternatively be another device, and embodiments of this application do not limit a specific form of the terminal. For ease of description, the following provides descriptions by using an example in which the terminal is a mobile phone.

With the rapid development of wireless communication technologies, the 4th generation mobile communication network (the 4th generation mobile communication technology, 4G) is evolving towards the 5th generation mobile communication technology (5G). For example, technical fields such as the Internet of Things (IoT), Internet of Vehicles (IoV), and multiple-input multiple-output (MIMO) have started to integrate with 5G communication systems. This will enable hundreds of millions of mobile phones to access 5G network platforms and apply the 5G systems in fields such as smart grid, smart healthcare, and smart transportation. Different communication frequency bands can be supported in different scenarios and different regions, for example, n257/n258/n261 (24.25 to 29.5 GHz) and n259/n260 (37.0 to 43.5 GHz).

As shown in FIG. 1, a time division duplexing (TDD) phased array system architecture may include a common path (CP), an intermediate stage channel (IS), and a subchannel (ch). In an example of this application, common paths include a CP 0 and a CP 1, intermediate stage channels include an IS 0, an IS 1, an IS 2, and an IS 3, and subchannels include ch0, ch1, ch2, ch3, ch4, ch5, ch6, ch7, ch8, ch9, ch10, ch11, ch12, ch13, ch14, and ch15.

The CP 0 may send a signal to the IS 1 and the IS 2. The IS 1 may send the received signal to ch4, ch5, ch6, and ch7 separately. The IS 2 may send the received signal to ch12, ch13, ch14, and ch15 separately. The CP 1 may send a signal to the IS 0 and the IS 3. The IS 0 may send the received signal to ch0, ch1, ch2, and ch3 separately. The IS 3 may send the received signal to ch8, ch9, ch10, and ch11 separately. Conversely, ch4, ch5, ch6, and ch7 may separately send signals to the IS 1. ch12, ch13, ch14, and ch15 may separately send signals to the IS 2. The IS 1 and the IS 2 may separately send received signals to the CP 0. ch0, ch1, ch2, and ch3 may separately send signals to the IS 0. ch8, ch9, ch10, and ch11 may separately send signals to the IS 3. The IS 0 and the IS 3 may separately send received signals to the CP 1.

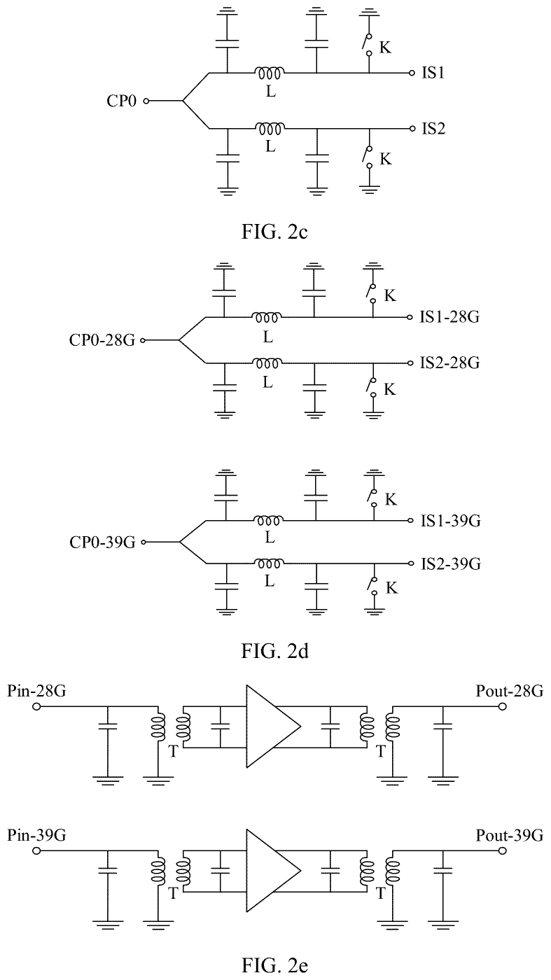

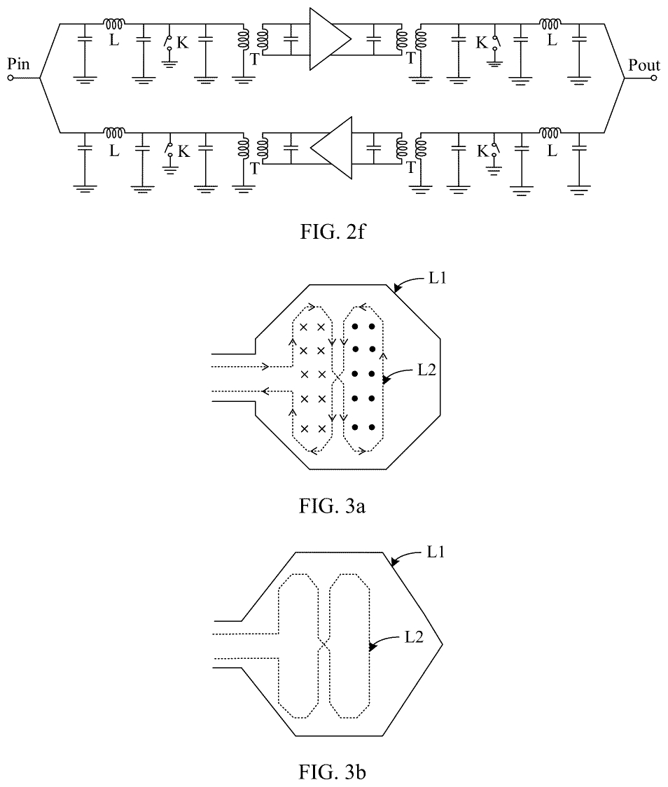

The foregoing process may be implemented by using a power divider/combiner. For example, a process in which the CP 0 sends signals to the IS 1 and the IS 2, and the IS 1 and the IS 2 separately send signals to the CP 0 may be implemented by using a single-frequency single-ended power divider/combiner shown in FIG. 2a. The single-frequency single-ended power divider/combiner has two branches, and an inductor L is disposed on each branch, that is, the single-frequency single-ended power divider/combiner includes the inductors L that are not coupled to each other. It should be noted herein that the single-frequency single-ended power divider/combiner may include a plurality of branches, a quantity of the plurality of branches is not limited to 2, and the single-frequency single-ended power divider/combiner may also include four branches, six branches, or the like. For ease of description, the following uses an example in which the single-frequency single-ended power divider/combiner includes two branches for description.

In some application scenarios, as shown in FIG. 2b, if a chip in a mobile phone supports dual-frequency communication, the power divider/combiner may alternatively be a dual-frequency single-ended power divider/combiner, so that the mobile phone implements communication in two different frequency bands. For example, the dual-frequency single-ended power divider/combiner includes one single-frequency single-ended power divider/combiner on a 28 GHz frequency band and one single-frequency single-ended power divider/combiner on a 39 GHz frequency band. The single-frequency single-ended power divider/combiner on the 28 GHz frequency band and the single-frequency single-ended power divider/combiner on the 39 GHz frequency band each have two branches, and one inductor L is disposed on each branch. In other words, the dual-frequency single-ended power divider/combiner includes the inductors L that are not coupled to each other.

In some application scenarios, as shown in FIG. 2c, two switches K may be further added on the basis of the single-frequency single-ended power divider/combiner. One end of one switch K is coupled to one branch of the single-frequency single-ended power divider/combiner, and the other end is grounded. One end of the other switch K is coupled to the other branch of the single-frequency single-ended power divider/combiner, and the other end is grounded, to form a single-frequency single-ended single-pole double-throw switch. When both switches are closed, no signal is sent between the CP 0, the IS 1, and the IS 2. When a switch coupled to a branch where the CP 0 and the IS 1 are located is closed, and a switch coupled to a branch where the CP 0 and the IS 2 are located is open, no signal is sent between the CP 0 and the IS 1, and a signal may be sent between the CP 0 and the IS 2.

Similarly, in some application scenarios, as shown in FIG. 2d, four switches K may be further added on the basis of the dual-frequency single-ended power divider/combiner, to form the dual-frequency single-ended single-pole double-throw switch. For a connection manner and an operating principle of the dual-frequency single-ended single-pole double-throw switch, refer to the single-frequency single-ended single-pole double-throw switch. Details are not described herein again. The dual-frequency single-ended single-pole double-throw switch includes four inductors L and four switches K.

In addition, because communication frequency bands vary in different regions, a 5G high-frequency phased array chip needs to support a plurality of frequency bands to operate in a plurality of regions. A dual-frequency amplifier is one of key circuits in the 5G high-frequency phased array chip. In addition, because the 5G high-frequency phased array chip is a time division duplexing phased array system, a bidirectional amplifier needs to be used to switch between receiving or transmitting a signal flow. Therefore, if the chip in the mobile phone supports dual-frequency communication, the dual-frequency amplifier and the bidirectional amplifier are indispensable circuits in the chip.

In some application scenarios, a user A uses a mobile phone A to make a call to a mobile phone B of a user B. In this process, a signal sent by the mobile phone A needs to reach a strength before being sent to a base station. Therefore, the mobile phone A needs to amplify the signal before sending the signal. The base station may send the received amplified signal to the mobile phone B. If the chip in the mobile phone A supports a 28 GHz frequency band and a 39 GHz frequency band, a process in which the mobile phone A amplifies the signal strength may be implemented through a dual-frequency amplifier. If the chip in the mobile phone A supports the 28 GHz frequency band or the 39 GHz frequency band, a process in which the mobile phone A amplifies the signal strength may be implemented through a single-band amplifier. As shown in FIG. 2e, a 5G high-frequency dual-frequency amplifier is used as an example. Implementation of the dual-frequency amplifier may include two single-band amplifiers. One single-band amplifier operates in the 28 GHz frequency band, and the other single-band amplifier operates in the 39 GHz frequency band. Each single-frequency amplifier includes two transformers T, and the dual-frequency amplifier includes four transformers T in total.

In some application scenarios, as shown in FIG. 2f, the mobile phone may further include a single-frequency bidirectional amplifier, configured to support a receive and transmit dual mode. The single-frequency bidirectional amplifier includes four inductors L, four transformers T, and four switches K.

All circuits such as the single-frequency single-ended power divider/combiner, the dual-frequency single-ended power divider/combiner, the single-frequency single-ended single-pole double-throw switch, the dual-frequency single-ended single-pole double-throw switch, the dual-frequency amplifier, and the single-frequency bidirectional amplifier each include a plurality of independent inductors L. A larger quantity of inductors L indicates a larger layout area occupied by the integrated circuit and even the chip, resulting in higher costs of the chip. Similarly, the dual-frequency amplifier and the single-frequency bidirectional amplifier further include a plurality of independent transformers. Each transformer may be formed by coupling two inductors L. A larger quantity of transformers indicates a larger layout area occupied by the integrated circuit and even the chip, resulting in higher costs of the chip. In addition, an existing dual-frequency amplifier and a single-frequency bidirectional amplifier need to rely on an active circuit to perform gain switching. This increases complexity of chip design and further increases power consumption of the chip.

To reduce a layout area occupied by the plurality of inductors L, embodiments of this application provide an integrated circuit. The integrated circuit includes a first inductor L1 and a second inductor L2. A relative position relationship between the first inductor L1 and the second inductor L2 is designed, to reduce a layout area occupied by the integrated circuit including plurality of inductors L.

The following describes the relative position relationship of the first inductor L1 and the second inductor L2 with reference to the accompanying drawings.

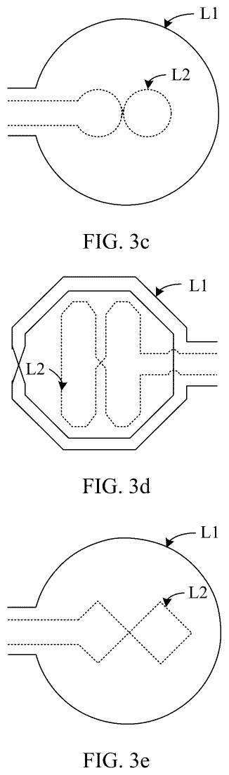

As shown in FIG. 3a to FIG. 3d, the first inductor L1 includes a first coil and a first lead, and the first coil is a loop having a first opening. An input end and an output end of the first coil are electrically connected to the first lead at the first opening.

The second inductor L2 includes a second coil and a third coil connected in series, and a second lead. The second coil has a second opening, and a magnetic field direction of the second coil is opposite to a magnetic field direction of the third coil. An input end and an output end of the second coil are electrically connected to the second lead at the second opening. The second coil and the third coil are nested in the first coil, and the first inductor L1 is not in direct contact with the second inductor L2.

It should be noted herein that the loop having the first opening refers to an unclosed geometric shape having a start point and an end point that are closely adjacent to each other and including at least one obvious convex part. In other words, a geometric shape having closed start point and end point and including at least one obvious convex part has the first opening.

For example, the loop includes one convex part. For example, as shown in FIG. 3a, the first coil may be an octagon with an opening on one side. For another example, as shown in FIG. 3b, the first coil may alternatively be a hexagon with an opening on one side. For another example, as shown in FIG. 3c, the first coil may alternatively be a circle having an opening.

For example, the loop includes two convex parts. For example, as shown in FIG. 3d, the first inductor L1 may be a spiral inductor, and the first coil may include two octagonal structures electrically connected to each other. One octagonal structure is closed, and one side of the other octagonal structure has an opening.

Certainly, the foregoing loop may be in another shape. This is not limited in embodiments of this application.

In some possible implementations, the second coil may include a first subloop and a first bent portion, and the third coil may include a second subloop and a second bent portion. The first bent portion and the second bent portion are configured to connect the first subloop and the second subloop. The first bent portion coincides with the second bent portion. The first subloop and the second subloop may be twisted through the first bent portion and the second bent portion, to form the second coil and the third coil that are connected in series.

Shapes of the first subloop and the second subloop may be closed geometric shapes that have a start point and an end point that are closely adjacent to each other and include at least one obvious convex part.

Optionally, as shown in FIG. 3a to FIG. 3c, the first subloop and the second subloop may be twisted through the first bent portion and the second bent portion, to form an 8-shaped shape.

For example, as shown in FIG. 3a and FIG. 3b, shapes of both the first subloop and the second subloop are polygons. For another example, as shown in FIG. 3c, shapes of both the first subloop and the second subloop are circles. Certainly, the first subloop and the second subloop may alternatively be in other shapes. This is not limited in embodiments of this application. The shapes of the first subloop and the second subloop may be the same or different.

In some possible implementations, the top of an 8-shape of the second coil may be an end part of a side that is of the first subloop and that is away from the second subloop.

Optionally, as shown in FIG. 3e, both the second coil and the third coil may be diamond-shaped.

Certainly, the second coil and the third coil may alternatively be of another shape. This is not limited in embodiments of this application.

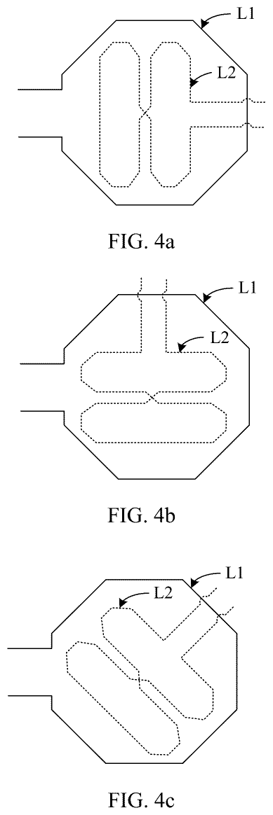

Directions of the first opening and the second opening, and a relative direction between the first opening and the second opening are not limited in embodiments of this application. In a possible implementation, as shown in FIG. 3a to FIG. 3d, the direction of the first opening may be the same as the direction of the second opening. In this case, the second lead of the second inductor L2 may not coincide with the first inductor L1, or the second lead of the second inductor L2 may partially coincide with the first inductor L1. In another possible implementation, as shown in FIG. 4a to FIG. 4c, the direction of the first opening may also be different from the direction of the second opening. In this case, the second lead of the second inductor L2 may coincide with the first inductor L1.

In some possible implementations, the chip may include a substrate and a plurality of conducting layers disposed on the substrate. Components in the integrated circuit may be obtained by patterning the conducting layers. For example, the plurality of patterned conducting layers may constitute the first inductor L1 and the second inductor L2 in this application, so that the first inductor L1 is not directly connected to the second inductor L2, and the second coil and the third coil are nested in the first coil. The second coil and the third coil are nested in the first coil, so that layout areas occupied by the second coil and the third coil can be omitted. In other words, a total area occupied by the first coil, the second coil, and the third coil is an area occupied by the first coil. Therefore, a total area of the first inductor L1 and the second inductor L2 is reduced. In comparison with a case in which the first inductor L1 and the second inductor L2 are separately disposed, the total area of the first inductor L1 and the second inductor L2 may be reduced by about 50%, thereby reducing costs of the chip.

Specifically, a disposing position relationship between the first inductor L1 and the second inductor L2 in the chip may include, for example, the following several cases.

In a first case, regardless of whether the first inductor L1 coincides with the second lead, the first coil and the first lead of the first inductor L1 and the second bent portion of the second inductor L2 are all disposed at a first layer. The first subloop of the second inductor L2, the second subloop, and the first bent portion are all disposed at a second layer. In addition, orthographic projections of the second coil and the third coil on a substrate are located within a range of orthographic projection of the first coil on the substrate, so that the second coil and the third coil are nested in the first coil. In this way, the first inductor L1 and the second inductor L2 can be implemented by using only two conducting layers. In addition, the first inductor L1 may not be in direct contact with the second inductor L2, so that the first bent portion is not in direct contact with the second bent portion, and this avoids a case in which the first subloop and the second subloop are short-circuited.

In a second case, if the first inductor L1 does not coincide with the second lead, the first coil and the first lead of the first inductor L1, and the second lead, the first bent portion, the first subloop, and the second subloop of the second inductor L2 are disposed at a same layer. The second bent portion of the second inductor L2 is disposed at a separate layer. In addition, orthographic projections of the second coil and the third coil on a substrate are located within a range of orthographic projection of the first coil on the substrate, so that the second coil and the third coil are nested in the first coil. In this way, the first inductor L1 and the second inductor L2 can be implemented by using only two conducting layers. In addition, the first inductor L1 may not be in direct contact with the second inductor L2, so that the first bent portion is not in direct contact with the second bent portion, and this avoids a case in which the first subloop and the second subloop are short-circuited.

In a third case, if the first inductor L1 at least partially coincides with the second lead, the first coil and the first lead of the first inductor L1 and the first bent portion, the first subloop, and the second subloop of the second inductor L2 are disposed at a same layer. The second bent portion of the second inductor L2 and the second lead are disposed at a same layer. In addition, orthographic projections of the second coil and the third coil on a substrate are located within a range of orthographic projection of the first coil on the substrate, so that the second coil and the third coil are nested in the first coil. In this way, the first inductor L1 and the second inductor L2 can be implemented by using only two conducting layers. In addition, the first inductor L1 may not be in direct contact with the second inductor L2, so that the first bent portion is not in direct contact with the second bent portion, and this avoids a case in which the first subloop and the second subloop are short-circuited.

In a fourth case, the first coil and the first lead of the first inductor L1 are both disposed at a first layer. The first subloop, the second subloop, and the first bent portion of the second inductor L2 are all disposed at the second layer, and the second bent portion of the second inductor L2 is disposed at the third layer. In addition, orthographic projections of the second coil and the third coil on a substrate are located within a range of orthographic projection of the first coil on the substrate. In this way, the first inductor L1 and the second inductor L2 may be implemented by using three conducting layers. In addition, the first inductor L1 may not be in direct contact with the second inductor L2, so that the first bent portion is not in direct contact with the second bent portion, and this avoids a case in which the first subloop and the second subloop are short-circuited.

It should be noted herein that, in the foregoing four cases, the second bent portion may be electrically connected to the first subloop and the second subloop respectively through an interlayer jumper.

Certainly, the first inductor L1 and the second inductor L2 may also be implemented by using more conducting layers or in another combination manner. A case is met that the first inductor L1 and the second inductor L2 are not in direct contact, and the first bent portion and the second bent portion are not in direct contact. Other forms made by a person skilled in the art under teachings of this application also fall within the protection of this application.

In addition, it should be noted that the first layer, the second layer, and the third layer are merely examples. In an actual process, the first layer, the second layer, and the third layer may also be other layers of the chip.

In addition, a direction indicated by an arrow in FIG. 3a shows a direction of a current flowing through the second inductor L2 in a possible application scenario. A signal is sent to the second inductor L2 through one end of the second lead, and the second inductor L2 may generate magnetic flux. According to a right-hand rule, directions of magnetic flux in the first subloop and the second subloop are opposite.

In some possible implementations, a magnitude of magnetic flux in a first subloop is equal to a magnitude of magnetic flux in a second subloop, and magnetic flux flowing through the first subloop and magnetic flux flowing through the second subloop cancel with each other. Therefore, as shown in FIG. 5a, for the first coil nested outside the second coil and the third coil, a sum of magnetic flux on the second coil and the third coil is 0, and the second inductor L2 is not coupled to the first inductor L1.

In some other possible implementations, a magnitude of magnetic flux in a first subloop is not equal to a magnitude of magnetic flux in a second subloop, and magnetic flux flowing through the first subloop and magnetic flux flowing through the second subloop partially cancel with each other, to adapt to a required application scenario.

In some embodiments, when the magnitude of the magnetic flux in the first subloop is not equal to the magnitude of the magnetic flux in the second subloop, as shown in FIG. 5b the second inductor L2 may further include a fourth coil connected in series to the second coil and the third coil, and the fourth coil is nested in the first coil. A magnetic field direction of the fourth coil is the same as the magnetic field direction of the second coil. A magnitude of magnetic flux in the third coil is equal to a magnitude of magnetic flux in the second coil and in the fourth coil. Magnetic flux flowing through the third coil and magnetic flux flowing through the second coil and the fourth coil cancel with each other. Therefore, as shown in FIG. 5a, for the first coil nested outside the second coil, the third coil, and the fourth coil, a sum of magnetic flux in the second coil, in the third coil, and in the fourth coil is 0, and the second inductor L2 is not coupled to the first inductor L1.

Certainly, the magnitude of the magnetic flux in the third coil may alternatively be different from the magnitude of the magnetic flux in the second coil and in the fourth coil, to adapt to a required application scenario. The second inductor L2 may further include more coils that are connected in series to the second coil, the third coil, and the fourth coil. This is not limited in embodiments of this application.

In addition, when the second inductor L2 includes the second coil, the third coil, the fourth coil, or even more coils, for positions for disposing the first inductor L1 and the second inductor L2 in the chip, refer to the foregoing description that the second inductor L2 includes the second coil and the third coil. Fewer layers of conducting layers occupied by the first inductor L1 and the second inductor L2 are preferred.

The foregoing first inductor L1 and the second inductor L2 that are not coupled to each other and that can reduce a chip layout area may be used in the foregoing circuits such as a single-frequency single-ended power divider/combiner, a dual-frequency single-ended power divider/combiner, a single-frequency single-ended single-pole double-throw switch, and a dual-frequency single-ended single-pole double-throw switch.

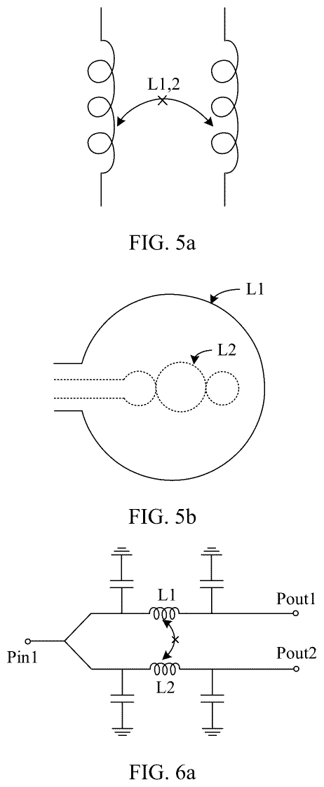

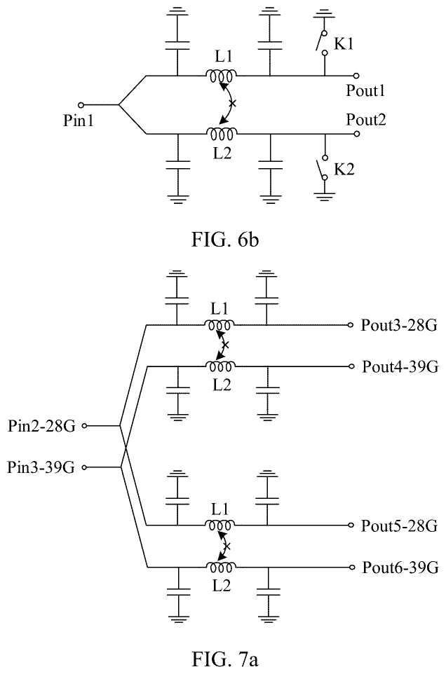

FIG. 6a is a circuit diagram of a single-frequency single-ended power divider/combiner. The single-frequency single-ended power divider/combiner includes a first input end Pin1, a first output end Pout1, and a second output end Pout2. A first inductor L1 is electrically connected between the first input end Pin1 and the first output end Pout1, and a second inductor L2 is electrically connected between the first input end Pin1 and the second output end Pout2.

As mentioned above, both branches of the single-frequency single-ended power divider/combiner include an inductor L, and the inductors L on the two branches are not coupled to each other. The first inductor L1 and the second inductor L2 in embodiments of this application can meet the foregoing requirements. In addition, because a total area occupied by the first coil, the second coil, and the third coil (or the first coil, the second coil, the third coil, and the fourth coil) is an area occupied by the first coil, by using the first inductor L1 and the second inductor L2 as the two inductors L of the single-frequency single-ended power divider/combiner, a layout area occupied by the single-frequency single-ended power divider/combiner can be reduced while ensuring normal operation of the single-frequency single-ended power divider/combiner. In comparison with the foregoing related technology corresponding to FIG. 2a, the layout area occupied by the single-frequency single-ended power divider/combiner can be reduced by about 50%, so that a layout area of a chip is reduced, and costs of the chip are reduced.

It should be noted that the single-frequency single-ended power divider/combiner may include a combiner and a power divider. In the foregoing naming manner, when the single-frequency single-ended power divider/combiner is used as the power divider, the first input end Pin1, the first output end Pout1, and the second output end Pout2 are named. The first input end Pin1 may separately send a signal to the first output end Pout1 and the second output end Pout2. When the single-frequency single-ended power divider/combiner is used as a combiner, the first output end Pout1 and the second output end Pout2 may be used as input ends, the first input end P1 may be used as an output end, and the first output end Pout1 and the second output end Pout2 may send a signal to the first input end Pin1.

FIG. 6b shows a circuit diagram of a single-frequency single-ended single-pole double-throw switch. Based on the single-frequency single-ended power divider/combiner, the integrated circuit further includes a first switch K1 and a second switch K2. One end of the first switch K1 is electrically connected between the first inductor L1 and the first output end Pout1, and the other end is grounded. One end of the second switch K2 is electrically connected between the second inductor L2 and the second output end Pout2, and the other end is grounded.

As mentioned above, both branches of the single-frequency single-ended single-pole double-throw switch include an inductor L, and the inductors L on the two branches are not coupled to each other. The first inductor L1 and the second inductor L2 in embodiments of this application can meet the foregoing requirements. In addition, because a total area occupied by the first coil, the second coil, and the third coil (or the first coil, the second coil, the third coil, and the fourth coil) is an area occupied by the first coil, by using the first inductor L1 and the second inductor L2 as the two inductors L of the single-frequency single-ended single-pole double-throw switch, a layout area occupied by the single-frequency single-ended single-pole double-throw switch can be reduced while ensuring normal operation of the single-frequency single-ended single-pole double-throw switch. In comparison with the foregoing related technology corresponding to FIG. 2c, the layout area occupied by the single-frequency single-ended single-pole double-throw switch may be reduced by about 50%, so that a layout area of a chip is reduced, and costs of the chip are reduced.

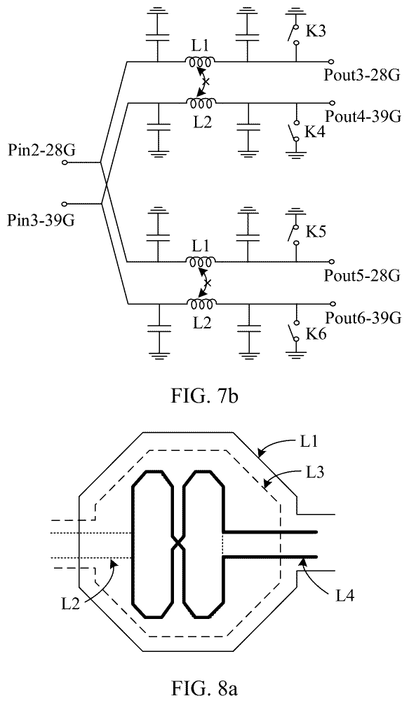

FIG. 7a shows a circuit diagram of a dual-frequency single-ended power divider/combiner. There are two first inductors L1 and two second inductors L2. An integrated circuit includes a second input end Pin2-28G, a third output end Pout3-28G, a fifth output end Pout5-28G, a third input end Pin3-39G, a fourth output end Pout4-39G, and a sixth output end Pout6-39G. One first inductor L1 is electrically connected between the second input end Pin2-28G and the third output end Pout3-28G, and the other first inductor L1 is electrically connected between the second input end Pin2-28G and the fifth output end Pout5-28G. One second inductor L2 is electrically connected between the third input end Pin3-39G and the fourth output end Pout4-39G, and the other second inductor L2 is electrically connected between the third input end Pin3-39G and the sixth output end Pout6-39G.

As mentioned above, the dual-frequency single-ended power divider/combiner includes two single-frequency single-ended power divider/combiners, which are separately configured to enable another communicable terminal like a mobile phone or a base station to work on a 28 GHz frequency band and a 39 GHz frequency band. The two single-frequency single-ended power divider/combiners include four branches in total, the four branches each include an inductor L, and the inductors L on the four branches are not coupled to each other. The first inductor L1 and the second inductor L2 in embodiments of this application can meet the foregoing requirements. In addition, because an area occupied by the first coil, the second coil, and the third coil (or the first coil, the second coil, the third coil, and the fourth coil) is an area occupied by the first coil, two inductor combinations may be provided. Each inductor combination includes one first inductor L1 and one second inductor L2, two first inductors L1 and two second inductors L2 in the two inductor combinations are used as the inductors L on the four branches of the dual-frequency single-ended power divider/combiner.

Specifically, the first inductor L1 in one inductor combination is electrically connected between the second input end Pin2-28G and the third output end Pout3-28G, and the second inductor L2 is electrically connected between the third input end Pin3-39G and the fourth output end Pout4-39G, the first inductor L1 in the other inductor combination is electrically connected between the second input end Pin2-28G and the fifth output end Pout3-28G, the second inductor L2 is electrically connected between the third input end Pin3-39G and the sixth output end Pout6-39G, so that it can be ensured that the dual-frequency single-ended power divider/combiner operates normally, and a layout area occupied by the dual-frequency single-ended power divider/combiner is reduced. In comparison with the related technology corresponding to FIG. 2b, the layout area occupied by the dual-frequency single-ended power divider/combiner may be reduced by about 50%, so that a layout area of a chip is reduced, and costs of the chip are reduced.

It should be noted that the dual-frequency single-ended power divider/combiner may include a combiner and a power divider. When the dual-frequency single-ended power divider/combiner is used as the power divider in the foregoing naming manner, the second input end Pin2-28G, the third input end Pin3-39G, the third output end Pout3-28G, the fourth output end Pout4-39G, the fifth output end Pout3-28G, and the sixth output end Pout6-39G are named. The second input end Pin2-28G may separately send a signal to the third output end Pout3-28G and the fifth output end Pout5-28G. The third input end Pin3-39G may separately send a signal to the fourth output end Pout4-39G and the sixth output end Pout6-39G.

When the dual-frequency single-ended power divider/combiner is used as the combiner, the third output end Pout3-28G, the fourth output end Pout4-39G, the fifth output end Pout3-28G, and the sixth output end Pout6-39G may alternatively be used as input ends, and the second input end Pin2-28G and the third input end Pin3-39G may alternatively be used as output ends. The third output end Pout3-28G and the fifth output end Pout5-28G may separately send a signal to the second input end Pin2-28G. The fourth output end Pout4-39G and the sixth output end Pout6-39G may separately send a signal to the third input end Pin3-39G.

FIG. 7b shows a circuit diagram of a dual-frequency single-ended single-pole double-throw switch. Based on the dual-frequency single-ended power divider/combiner, the integrated circuit further includes a third switch K3, a fourth switch K4, a fifth switch K5, and a sixth switch K6. One end of the third switch K3 is electrically connected between one first inductor L1 and the third output end Pout3-28G, and the other end is grounded. One end of the fourth switch K4 is electrically connected between one second inductor L2 and the fourth output end Pout4-39G, and the other end is grounded. One end of the fifth switch K5 is electrically connected between the other first inductor L1 and the fifth output end Pout3-28G, and the other end is grounded. One end of the sixth switch K6 is electrically connected between the other second inductor L2 and the sixth output end Pout6-39G, and the other end is grounded.

As mentioned above, each of the four branches of the dual-frequency single-ended single-pole double-throw switch includes an inductor L, and inductors on the four branches are not coupled to each other. The first inductor L1 and the second inductor L2 in embodiments of this application may meet the foregoing requirements. In addition, because an area occupied by the first coil, the second coil, and the third coil (or the first coil, the second coil, the third coil, and the fourth coil) is an area occupied by the first coil, two inductor combinations may be provided. Each inductor combination includes a first inductor L1 and a second inductor L2, two first inductors L1 and two second inductors L2 in the two inductor combinations are used as the inductors L on the four branches of the dual-frequency single-ended single-pole double-throw switch.

Specifically, the first inductor L1 in one inductor combination is electrically connected between the second input end Pin2-28G and the third output end Pout3-28G, and the second inductor L2 is electrically connected between the third input end Pin3-39G and the fourth output end Pout4-39G, the first inductor L1 in another inductor combination is electrically connected between the second input end Pin2-28G and the fifth output end Pout3-28G, the second inductor L2 is electrically connected between the third input end Pin3-39G and the sixth output end Pout6-39G, so that it can be ensured that the dual-frequency single-ended power divider/combiner operates normally, and a layout area occupied by the dual-frequency single-ended power divider/combiner is reduced. In comparison with the related technology corresponding to FIG. 2b, the layout area occupied by the dual-frequency single-ended power divider/combiner may be reduced by about 50%, so that a layout area of a chip is reduced, and costs of the chip are reduced.

In addition, the protection scope of this application is not limited to the foregoing circuits such as the single-frequency single-ended power divider/combiner, the dual-frequency single-ended power divider/combiner, the single-frequency single-ended single-pole double-throw switch, and the dual-frequency single-ended single-pole double-throw switch. A person skilled in the art should know that, under teachings of embodiments of this application, any circuit using the foregoing at least one inductor combination falls within the protection of embodiments of this application.

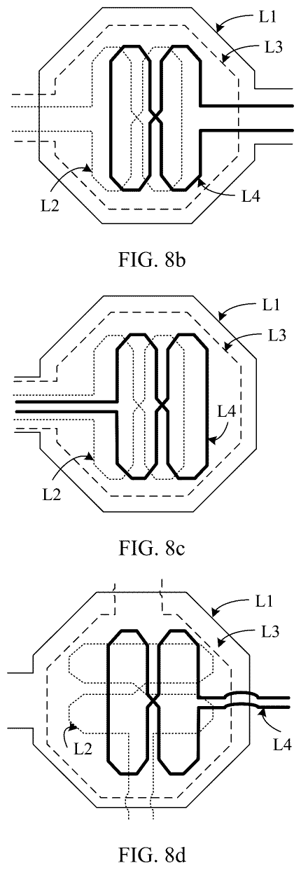

In some embodiments, as shown in FIG. 8a and FIG. 8b, the integrated circuit may further include a third inductor L3 and a fourth inductor L4. The third inductor L3 includes a fifth coil and a third lead, and the fifth coil is a loop having a third opening. An input end and an output end of the fifth coil are electrically connected to the third lead at the third opening.

The fourth inductor L4 includes a sixth coil and a seventh coil that are connected in series, and a fourth lead. The sixth coil has a fourth opening, and a magnetic field direction of the sixth coil is opposite to a magnetic field direction of the seventh coil. An input end and an output end of the sixth coil are electrically connected to the fourth lead at the fourth opening. The fifth coil is nested in the first coil, and the third coil, the fourth coil, the sixth coil, and the seventh coil are nested in the fifth coil. The first inductor L1, the second inductor L2, the third inductor L3, and the fourth inductor L4 are not in direct contact.

It should be noted herein that the loop having the third opening refers to an unclosed geometric shape having a start point and an end point that are closely adjacent to each other and including at least one obvious convex part. In other words, a geometric shape having closed start point and end point and including at least one obvious convex part has the third opening. A shape of the fifth coil may be the same as or different from a shape of the first coil, provided that the fifth coil is nested in the first coil.

In some possible implementations, the sixth coil may include a third subloop and a third bent portion, and the seventh coil may include a fourth subloop and a fourth bent portion. The third bent portion and the fourth bent portion are configured to connect the third subloop and the fourth subloop. The third bent portion coincides with the fourth bent portion. The third subloop and the fourth subloop may be twisted through the third bent portion and the fourth bent portion, to form the sixth coil and the seventh coil that are connected in series.

Shapes of the third subloop and the fourth subloop may be closed geometric shapes that have a start point and an end point that are closely adjacent to each other and include at least one obvious convex part. The shapes of the third subloop and the fourth subloop may be the same as or different from shapes of the first subloop and the second subloop. The shape of the third subloop may be the same as or different from the shape of the fourth subloop.

Optionally, the third subloop and the fourth subloop may be twisted through the third bent portion and the fourth bent portion, to form an 8-shaped shape. Alternatively, optionally, both the sixth coil and the seventh coil may be diamond-shaped. Certainly, the sixth coil and the seventh coil may alternatively be of another shape. This is not limited in embodiments of this application.

In some possible implementations, the top of an 8-shape of the fourth coil may be an end part of a side that is of the third subloop and that is away from the fourth subloop.

In some possible implementations, a relative position relationship between the second coil and the third coil and between the sixth coil and the seventh coil is not limited in this application, provided that the second coil, the third coil, the sixth coil, and the seventh coil are all nested in the fifth coil. As shown in FIG. 8a, orthographic projections of the second coil and the sixth coil on a substrate coincide, and orthographic projections of the third coil and the seventh coil on the substrate coincide. As shown in FIG. 8b, orthographic projections of the second coil and the sixth coil on the substrate are disposed in a staggered manner, and orthographic projections of the third coil and the seventh coil on the substrate are disposed in a staggered manner.

In some possible implementations, a direction of the first opening, a direction of the second opening, a direction of the third opening, a direction of the fourth opening, and relative directions between the first opening, the second opening, the third opening, and the fourth opening are not limited in embodiments of this application.

In a possible implementation, as shown in FIG. 8c, the direction of the first opening, the direction of the second opening, the direction of the third opening, and the direction of the fourth opening may all be the same. As shown in FIG. 8a and FIG. 8b, in another possible implementation, at least two of the direction of the first opening, the direction of the second opening, the direction of the third opening, and the direction of the fourth opening is the same. In still another possible implementation, as shown in FIG. 8d, the direction of the first opening, the direction of the second opening, the direction of the third opening, and the direction of the fourth opening are all different.

Optionally, the direction of the first opening is disposed opposite to the direction of the third opening, and the direction of the second opening is disposed opposite to the direction of the fourth opening. This helps implement signal connection more easily during layout design.

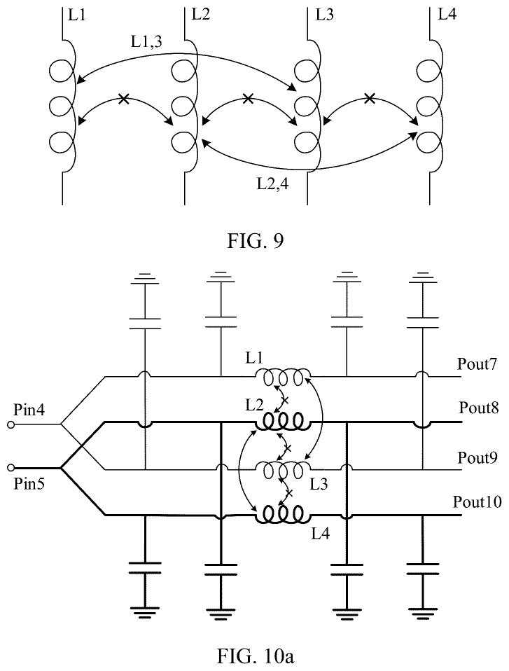

In addition, as shown in FIG. 9, the first inductor L1 and the second inductor L2 are not coupled to each other, the third inductor L3 and the fourth inductor L4 are not coupled to each other, the first inductor L1 and the fourth inductor L4 are not coupled to each other, and the second inductor L2 and the third inductor L3 are also not coupled to each other. For the first inductor L1 and the third inductor L3, the first inductor L1 and the third inductor L3 may be coupled to each other, and the first inductor L1 and the third inductor L3 may form a transformer. For the second inductor L2 and the fourth inductor L4, the second inductor L2 and the fourth inductor L4 may be coupled to each other, and the second inductor L2 and the fourth inductor L4 may form a transformer.

In some possible implementations, patterned conducting layers may further constitute the third inductor L3 and the fourth inductor L4 in this application, and the first inductor L1, the second inductor L2, the third inductor L3, and the fourth inductor L4 are not in direct contact. In addition, the fifth coil is nested in the first coil. The second coil, the third coil, the sixth coil, and the seventh coil are nested in the fifth coil, so that layout areas occupied by the second coil, the third coil, the fifth coil, the sixth coil, and the seventh coil can be omitted. In other words, a total area occupied by the first coil, the second coil, the third coil, the fifth coil, the sixth coil, and the seventh coil is an area occupied by the first coil. Therefore, the total area of the first inductor L1, the second inductor L2, the third inductor L3, and the fourth inductor L4 is reduced. In comparison with the case in which the two transformers are separately disposed, a total area of the two transformers including the first inductor L1 and the third inductor L3, and the second inductor L2 and the fourth inductor L4 may be reduced by about 50%, thereby reducing costs of the chip.

Specifically, as shown in FIG. 8b, when the second coil and the third coil are respectively staggered from the sixth coil and the seventh coil, so that the first bent portion and the second bent portion are staggered from the third bent portion and the fourth bent portion respectively, if the first lead does not coincide with the fourth lead, and the second lead does not coincide with the third lead, the first coil and the first lead of the first inductor L1, the second bent portion, the fifth coil, the third subloop, the fourth subloop, the fourth bent portion, and the fourth lead are disposed at a same layer. The first subloop, the second subloop, the first bent portion, the second lead, the third lead, and the third bent portion are disposed at a same layer. In addition, orthographic projections of the second coil, the third coil, the sixth coil, and the seventh coil on a substrate are located within a range of orthographic projections of the fifth coil on the substrate. An orthographic projection of the fifth coil on the substrate is located within a range of an orthographic projection of the first coil on the substrate. In this way, the first inductor L1, the second inductor L2, the third inductor L3, and the fourth inductor L4 can be implemented by using only two conducting layers.

A person skilled in the art should know that, under teachings of this application, other solutions in which the first inductor L1, the second inductor L2, the third inductor L3, and the fourth inductor L4 may be implemented by using two or more conducting layers all fall within the protection of this application.

Certainly, when the second coil coincides with the sixth coil, and the third coil coincides with the seventh coil, a first conducting layer and a second conducting layer may be added based on the foregoing two conducting layers. The first conducting layer includes a second bent portion, and the second conducting layer includes a third bent portion.

In addition, as shown in FIG. 8b, a signal is sent to the fourth inductor L4 through one end of the fourth lead, and the fourth inductor L4 may generate magnetic flux. According to a right-hand rule, directions of the magnetic flux in the third subloop and the fourth subloop are opposite.

In some possible implementations, a magnitude of magnetic flux in the third subloop is equal to a magnitude of magnetic flux in the fourth subloop, and magnetic flux flowing through the third subloop and the fourth subloop cancel with each other. Therefore, for the first coil and the fifth coil that are nested outside the sixth coil and the seventh coil, a sum of magnetic flux on the sixth coil and the seventh coil is 0, and the second inductor L2 is not coupled to the first inductor L1 and the third inductor L3.

In some other possible implementations, a magnitude of magnetic flux in the third subloop is not equal to a magnitude of magnetic flux in the fourth subloop, and magnetic flux flowing through the third subloop and magnetic flux flowing through the fourth subloop partially cancel with each other, to adapt to a required application scenario.

In some embodiments, when a magnitude of magnetic flux in the third subloop is not equal to a magnitude of magnetic flux in the fourth subloop, the second inductor L2 may further include an eighth coil connected in series to the sixth coil and the seventh coil, and the eighth coil is nested in the fifth coil. A magnetic field direction of the eighth coil is the same as a magnetic field direction of the sixth coil. A magnitude of magnetic flux in the seventh coil is equal to a magnitude of magnetic flux in the sixth coil and the eighth coil. Magnetic flux flowing through the seventh coil and magnetic flux flowing through the sixth coil and the eighth coil cancel with each other. Therefore, for the fifth coil and the first coil that are nested outside the sixth coil, the seventh coil, and the eighth coil, a sum of magnetic flux on the sixth coil, the seventh coil, and the eighth coil is 0, and the fourth inductor L4 is not coupled to the first inductor L1 and the third inductor L3.

Certainly, the magnitude of the magnetic flux in the seventh coil may alternatively be different from the magnitude of the magnetic flux in the sixth coil and the eighth coil, to adapt to a required application scenario. The fourth inductor L4 may further include more coils that are connected in series to the sixth coil, the seventh coil, and the eighth coil. This is not limited in embodiments of this application.

In addition, when the fourth inductor L4 includes the sixth coil, the seventh coil, the eighth coil, or even more coils, for positions for disposing the first inductor L1, the second inductor L2, the third inductor L3, and the fourth inductor L4 in the chip, refer to the foregoing description that the fourth inductor L4 includes the sixth coil and the seventh coil. Fewer layers of conducting layers occupied by the first inductor L1, the second inductor L2, the third inductor L3, and the fourth inductor L4 are preferred.

The first inductor L1, the second inductor L2, the third inductor L3, and the fourth inductor L4 that can reduce the chip layout area may be used in circuits such as the single-frequency differential power divider/combiner, the dual-frequency differential power divider/combiner, the single-frequency differential single-pole double-throw switch, and the dual-frequency differential single-pole double-throw switch.

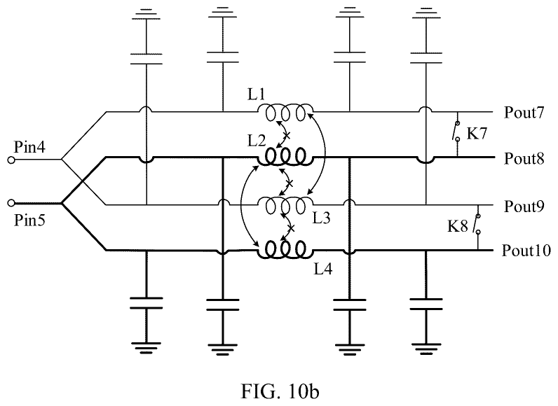

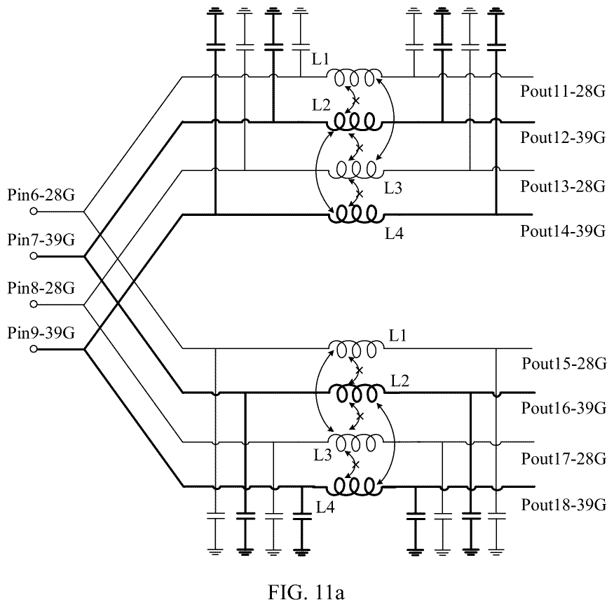

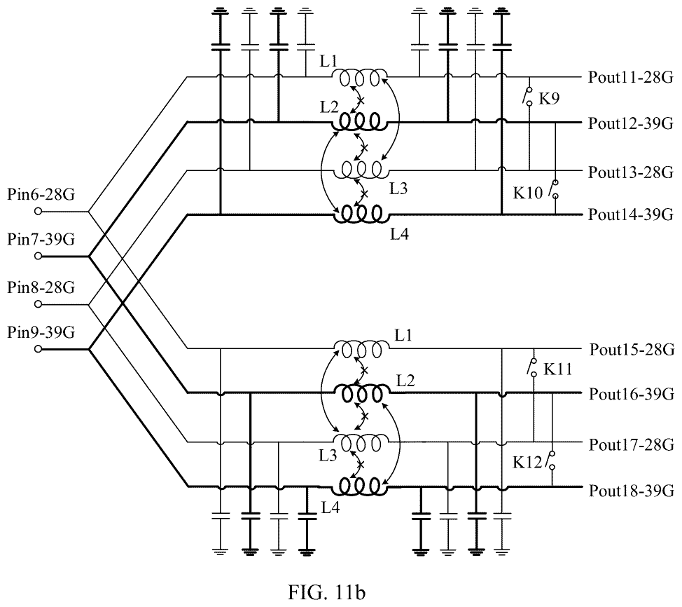

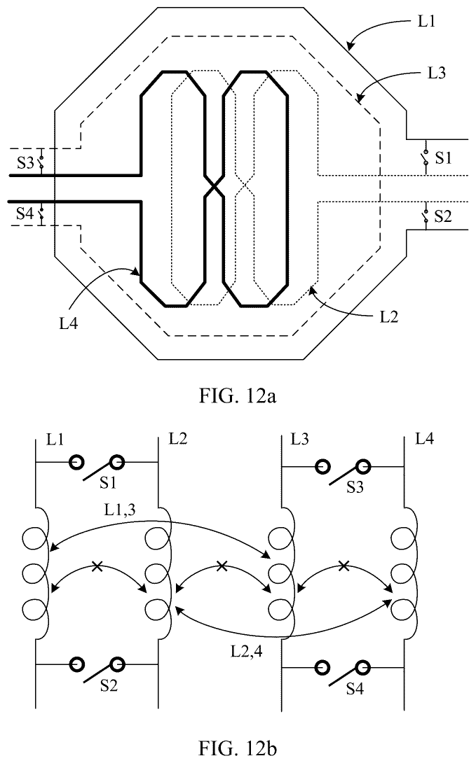

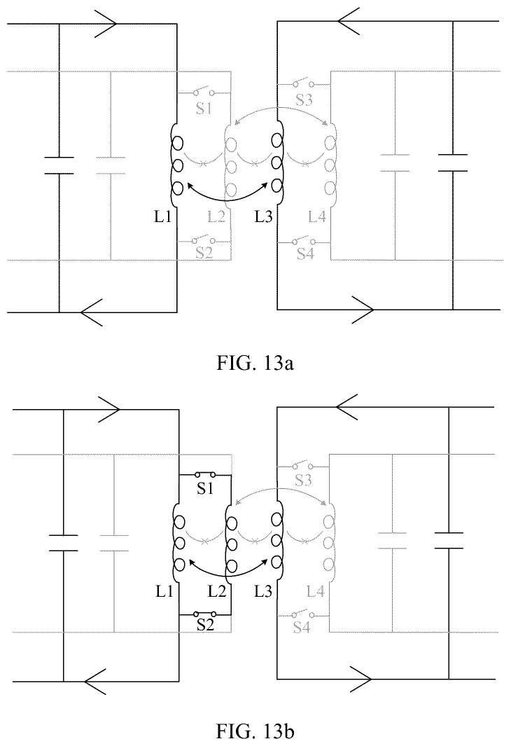

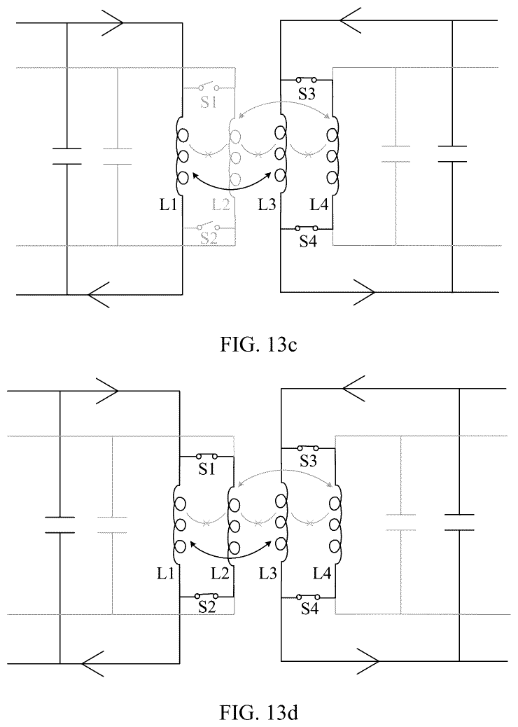

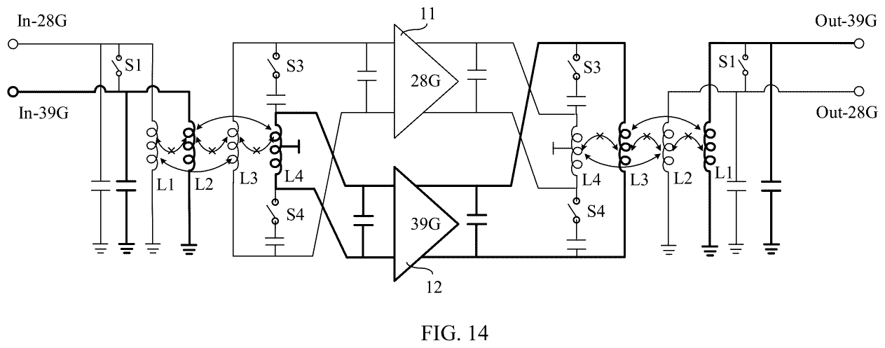

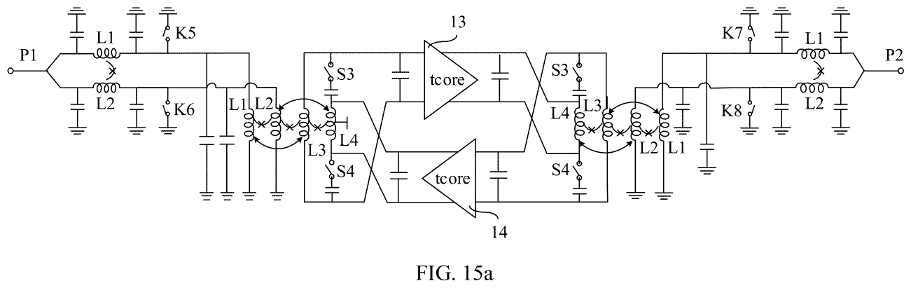

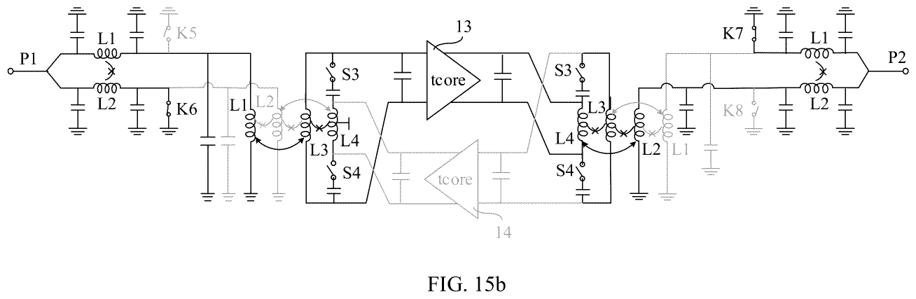

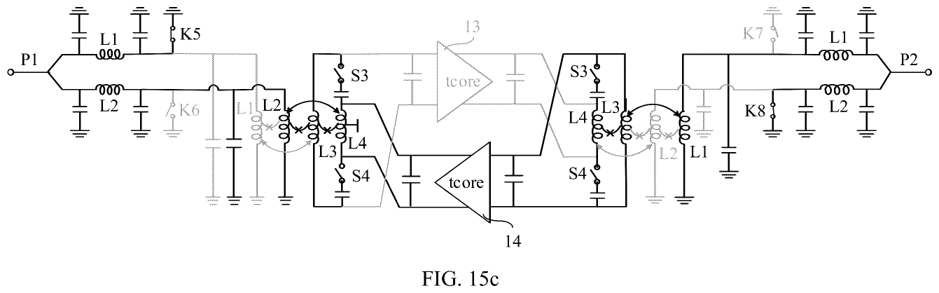

FIG. 10a shows a circuit diagram of a single-frequency differential power divider/combiner. The integrated circuit further includes a fourth input end Pin4, a fifth input end Pin5, a seventh output end Pout7, an eighth output end Pout8, a ninth output end Pout9, and a tenth output end Pout10. The first inductor L1 is electrically connected between the fourth input end Pin4 and the seventh output end Pout7. The second inductor L2 is electrically connected between the fifth input end Pin5 and the eighth output end Pout8. The third inductor L3 is electrically connected between the fourth input end Pin4 and the ninth output end Pout9. The fourth inductor L4 is electrically connected between the fifth input end Pin5 and the tenth output end Pout10.

The single-frequency differential power divider/combiner includes two single-frequency single-ended power divider/combiners. Two branches of each single-frequency single-ended power divider/combiner include an inductor L. Two inductors L on two branches of a same single-frequency single-ended power divider/combiner may be coupled to each other, and two inductors L on branches of different single-frequency single-ended power divider/combiners cannot be coupled to each other. When the two inductors L on the two branches of the same single-frequency single-ended power divider/combiner may be coupled to each other, mutual reference may be made between signals transmitted on the two branches of the single-frequency single-ended power divider/combiner.

The first inductor L1, the second inductor L2, the third inductor L3, and the fourth inductor L4 in embodiments of this application can meet the foregoing requirements. In addition, a total area occupied by the first coil, the second coil, the third coil, the fifth coil, the sixth coil, and the seventh coil is an area occupied by the first coil. Therefore, the first inductor L1 and the third inductor L3 are used as two inductors L of one single-frequency single-ended power divider/combiner, and the second inductor L2 and the fourth inductor L4 are used as two inductors L of another single-frequency single-ended power divider/combiner. The first inductor L1 and the second inductor L2 are not coupled to each other, the third inductor L3 and the fourth inductor L4 are not coupled to each other, the first inductor L1 and the third inductor L3 are coupled to each other, and the second inductor L2 and the fourth inductor L4 are coupled to each other. In this way, a layout area occupied by the single-frequency differential power divider/combiner can be reduced while ensuring normal operation of the single-frequency differential power divider/combiner. In comparison with another single-frequency differential power divider/combiner, a layout area of the single-frequency differential power divider/combiner in this application may be reduced by about 50%, thereby reducing a layout area of a chip and reducing costs of the chip.

It should be noted that the single-frequency differential power divider/combiner may include a combiner and a power divider. In the foregoing naming manner, when the single-frequency differential power divider/combiner is used as the power divider, the fourth input end Pin4, the fifth input end Pin5, the seventh output end Pout7, the eighth output end Pout8, the ninth output end Pout9, and the tenth output end Pout10 are named. When the single-frequency differential power divider/combiner is used as a combiner, the seventh output end Pout7, the eighth output end Pout8, the ninth output end Pout9, and the tenth output end Pout10 may also be used as input ends, and the fourth input end Pin4 and the fifth input end Pin5 may also be used as output ends.

FIG. 10b shows a circuit diagram of a single-frequency differential single-pole double-throw switch. Based on the foregoing single-frequency differential power divider/combiner, the integrated circuit further includes a seventh switch K7 and an eighth switch K8. One end of the seventh switch K7 is electrically connected between the first inductor L1 and the seventh output end Pout7, and the other end is electrically connected between the second inductor L2 and the eighth output end Pout8. One end of the eighth switch K8 is electrically connected between the third inductor L3 and the ninth output end Pout9, and the other end is electrically connected between the fourth inductor L4 and the tenth output end Pout10.

When both the seventh switch K7 and the eighth switch K8 are open, each branch of the single-frequency differential power divider/combiner can operate.

When the seventh switch K7 is closed and the eighth switch K8 is open, a branch in which the fourth input end Pin4, the first inductor L1, and the seventh output end Pout7 are located does not operate, and a branch in which the fifth input end Pin5, the second inductor L2, and the eighth output end Pout8 are located does not operate. A branch in which the fourth input end Pin4, the third inductor L3, and the ninth output end Pout9 are located operates, and a branch in which the fifth input end Pin5, the fourth inductor L4, and the tenth output end Pout10 are located operates.

When the seventh switch K7 is open and the eighth switch K8 is closed, a branch in which the fourth input end Pin4, the first inductor L1, and the seventh output end Pout7 are located operates, and a branch in which the fifth input end Pin5, the second inductor L2, and the eighth output end Pout8 are located operates. A branch in which the fourth input end Pin4, the third inductor L3, and the ninth output end Pout9 are located does not operate, and a branch in which the fifth input end Pin5, the fourth inductor L4, and the tenth output end Pout10 are located does not operate.

When both the seventh switch K7 and the eighth switch K8 are closed, each branch of the single-frequency differential power divider/combiner does not operate.

In this application, the seventh switch K7 and the eighth switch K8 are controlled to be open or closed, so that whether the two single-frequency single-ended power divider/combiners in the single-frequency differential power divider/combiners operate can be controlled, to implement signal transmission in different scenarios.

FIG. 11a shows a circuit diagram of a dual-frequency differential power divider/combiner. A quantity of first inductors L1, a quantity of second inductors L2, a quantity of third inductors L3, and a quantity of fourth inductors L4 are all two. The integrated circuit further includes a sixth input end Pin6-28G, a seventh input end Pin7-39G, an eighth input end Pin8-28G, a ninth input end Pin9-39G, an eleventh output end Pout11-28G, a twelfth output end Pout12-39G, a thirteenth output end Pout13-28G, a fourteenth output end Pout14-39G, a fifteenth output end Pout15-28G, a sixteenth output end Pout16-39G, a seventeenth output end Pout17-28G, and an eighteenth output end Pout18-39G.

One first inductor L1 is electrically connected between the sixth input end Pin6-28G and the eleventh output end Pout11-28G, and the other first inductor L1 is electrically connected between the sixth input end Pin6-28G and the fifteenth output end Pout15-28G. One second inductor L2 is electrically connected between the seventh input end Pin7-39G and the twelfth output end Pout12-39G, and the other second inductor L2 is electrically connected between the seventh input end Pin7-39G and the sixteenth output end Pout16-39G. One third inductor L3 is electrically connected between the eighth input end Pin8-28G and the thirteenth output end Pout13-28G, and the other third inductor L3 is electrically connected between the eighth input end Pin8-28G and the seventeenth output end Pout17-28G. One fourth inductor L4 is electrically connected between the ninth input end Pin9-39G and the fourteenth output end Pout14-39G, and the other fourth inductor L4 is electrically connected between the ninth input end Pin9-39G and the eighteenth output end Pout18-39G.

The dual-frequency differential power divider/combiner includes two pairs of single-frequency differential power divider/combiners. One pair of single-frequency differential power divider/combiners is configured to transmit a signal of a 28 GHz frequency band, and the other pair of single-frequency differential power divider/combiners is configured to transmit a signal of a 39 GHz frequency band. The two pairs of single-frequency differential power divider/combiners include eight branches in total, each branch may include one inductor L, and there are eight inductors L in total. The pair of single-frequency differential power divider/combiners configured to transmit the 28 GHz frequency band includes the sixth input end Pin6-28G, the eleventh output end Pout11-28G, the fifteenth output end Pout15-28G, the eighth input end Pin8-28G, the thirteenth output end Pout13-28G, and the seventeenth output end Pout17-28G. The pair of single-frequency differential power divider/combiners configured to transmit the 39 GHz frequency band includes the seventh input end Pin7-39G, the twelfth output end Pout12-39G, the sixteenth output end Pout16-39G, the ninth input end Pin9-39G, the fourteenth output end Pout14-39G, and the eighteenth output end Pout18-39G.

Embodiments of this application may provide two inductor combinations. Each inductor combination includes one first inductor L1, one second inductor L2, one third inductor L3, and one fourth inductor L4. In addition, a total area occupied by the first coil, the second coil, the third coil, the fifth coil, the sixth coil, and the seventh coil is an area occupied by the first coil. Therefore, the two first inductors L1, the two second inductors L2, the two third inductors L3, and the two fourth inductors L4 in the two inductor combinations are used as inductors L on eight branches of the dual-frequency differential power divider/combiner.

Specifically, the first inductor L1 in the inductor combination is electrically connected between the sixth input end Pin6-28G and the eleventh output end Pout11-28G, the second inductor L2 is electrically connected between the seventh input end Pin7-39G and the twelfth output end Pout12-39G, the third inductor L3 is electrically connected between the eighth input end Pin8-28G and the thirteenth output end Pout13-28G, and the fourth inductor L4 is electrically connected between the ninth input end Pin9-39G and the fourteenth output end Pout14-39. Therefore, the first inductor L1 in the inductor combination is coupled to the third inductor L3, and the second inductor L2 is coupled to the fourth inductor L4. In this way, in this inductor combination, a signal on the first inductor L1 and a signal on the third inductor L3 may be mutually referenced, and a signal on the second inductor L2 and a signal on the fourth inductor L4 may be mutually referenced.

The first inductor L1 in another inductor combination is electrically connected between the sixth input end Pin6-28G and the fifteenth output end Pout15-28G, the second inductor L2 is electrically connected between the seventh input end Pin7-39G and the sixteenth output end Pout16-39G, the third inductor L3 is electrically connected between the eighth input end Pin8-28G and the seventeenth output end Pout17-28G, and the fourth inductor L4 is electrically connected between the ninth input end Pin9-39G and the eighteenth output end Pout18-39G. Therefore, the first inductor L1 in the inductor combination is coupled to the third inductor L3, and the second inductor L2 is coupled to the fourth inductor L4. In this way, in this inductor combination, a signal on the first inductor L1 and a signal on the third inductor L3 may be mutually referenced, and a signal on the second inductor L2 and a signal on the fourth inductor L4 may be mutually referenced.

In addition, in a case in which normal operation of the dual-frequency differential power divider/combiner is ensured, a layout area occupied by the dual-frequency differential power divider/combiner can be reduced, thereby reducing a layout area of the chip and reducing costs of the chip.

It should be noted that the dual-frequency differential power divider/combiner may include a combiner and a power divider. When the dual-frequency differential power divider/combiner is used as the power divider in the foregoing naming manner, the sixth input end Pin6-28G, the seventh input end Pin7-39G, the eighth input end Pin8-28G, the ninth input end Pin9-39G, the eleventh output end Pout11-28G, the twelfth output end Pout12-39G, the thirteenth output end Pout13-28G, the fourteenth output end Pout14-39G, the fifteenth output end Pout15-28G, the sixteenth output end Pout16-39G, the seventeenth output end Pout17-28G, and the eighteenth output end Pout18-39G are named. When the dual-frequency differential power divider/combiner is used as the combiner, the eleventh output end Pout11-28G, the twelfth output end Pout12-39G, the thirteenth output end Pout13-28G, the fourteenth output end Pout14-39G, the fifteenth output end Pout15-28G, the sixteenth output end Pout16-39G, the seventeenth output end Pout17-28G, and the eighteenth output end Pout18-39G may also be used as input ends, and the sixth input end Pin6-28G, the seventh input end Pin7-39G, the eighth input end Pin8-28G, and the ninth input end Pin9-39G may also be used as output ends.

FIG. 11b shows a circuit diagram of a dual-frequency differential single-pole double-throw switch. Based on the foregoing single-frequency differential power divider/combiner, the integrated circuit further includes a ninth switch K9, a tenth switch K10, an eleventh switch K11, and a twelfth switch K12. One end of the ninth switch K9 is electrically connected between the first inductor L1 and the eleventh output end Pout11-28G, and the other end is electrically connected between the third inductor L3 and the thirteenth output end Pout13-28G. One end of the tenth switch K10 is electrically connected between the second inductor L2 and the twelfth output end Pout12-39G, and the other end is electrically connected between the fourth inductor L4 and the fourteenth output end Pout14-39G. One end of the eleventh switch K11 is electrically connected between the first inductor L1 and the fifteenth output end Pout15-28G, and the other end is electrically connected between the third inductor L3 and the seventeenth output end Pout17-28G. One end of the twelfth switch K12 is electrically connected between the second inductor L2 and the sixteenth output end Pout16-39G, and the other end is electrically connected between the fourth inductor L4 and the eighteenth output end Pout18-39G.

When the ninth switch K9, the tenth switch K10, the eleventh switch K11, and the twelfth switch K12 are all open, each branch of the dual-frequency differential power divider/combiner can operate.

When the ninth switch K9 and the eleventh switch K1l are open, and the tenth switch K10 and the twelfth switch K12 are closed, a single-frequency differential power divider/combiner configured to transmit a 28 GHz frequency band operates, and a single-frequency differential power divider/combiner configured to transmit a 39 GHz frequency band does not operate.

When the ninth switch K9 and the eleventh switch K1l are closed, and the tenth switch K10 and the twelfth switch K12 are open, the single-frequency differential power divider/combiner configured to transmit the 28 GHz frequency band does not operate, and the single-frequency differential power divider/combiner configured to transmit the 39 GHz frequency band operates.

When the ninth switch K9, the tenth switch K10, the eleventh switch K11, and the twelfth switch K12 are all closed, each branch of the dual-frequency differential power divider/combiner does not operate.

In this application, the ninth switch K9, the tenth switch K10, the eleventh switch K11, and the twelfth switch K12 are controlled to be open or closed, to control whether two pairs of single-frequency differential power divider/combiners in the dual-frequency differential power divider/combiners operate, to implement signal transmission in different scenarios.

As shown in FIG. 12a and FIG. 12b, embodiments of this application further provide an integrated circuit. The integrated circuit includes a first transformer, a second transformer, a first switch S1, a second switch S2, a third switch S3, and a fourth switch S4. The first transformer includes a first inductor L1 and a third inductor L3, where the first inductor L1 and the third inductor L3 are coupled to each other. The second transformer includes a second inductor L2 and a fourth inductor L4, where the second inductor L2 and the fourth inductor L4 are coupled to each other. The first inductor L1 is connected in parallel to the second inductor L2 through the first switch S1 and the second switch S2, and the third inductor L3 is connected in parallel to the fourth inductor L4 through the third switch S3 and the fourth switch S4.

In addition, the first inductor L1 is not coupled to the second inductor L2 and the fourth inductor L4, and the third inductor L3 is not coupled to the second inductor L2 and the fourth inductor L4.

The first switch S1 is electrically connected between an input end of the first inductor L1 and an input end of the second inductor L2, and the second switch S2 is electrically connected between an output end of the first inductor L1 and an output end of the second inductor L2. The third switch S3 is electrically connected between an input end of the third inductor L3 and an input end of the fourth inductor L4, and the fourth switch S4 is electrically connected between an output end of the third inductor L3 and an output end of the fourth inductor L4.

When the first transformer and the second transformer including the first inductor L1, the second inductor L2, the third inductor L3, and the fourth inductor L4 are used in an actual circuit, a gain of the circuit including the first inductor L1, the second inductor L2, the third inductor L3, and the fourth inductor L4 may be adjusted by closing or opening any one of the first switch S1, the second switch S2, the third switch S3, and the fourth switch S4.

The following describes a gain change of the circuit where the first inductor L1, the second inductor L2, the third inductor L3, and the fourth inductor L4 are located by using an example in which a loop in which the first transformer is located operates and a loop in which the second transformer is located does not operate.

As shown in FIG. 13a, when the first switch S1, the second switch S2, the third switch S3, and the fourth switch S4 are all open, because both the second inductor L2 and the fourth inductor L4 are not coupled to the first inductor L1 and the third inductor L3, the loop in which the first transformer is located can operate normally, and the second inductor L2 and the fourth inductor L4 do not affect the first transformer. In this case, a gain of the loop in which the first transformer is located is the largest.

As shown in FIG. 13b, when the first switch S1 and the second switch S2 are closed, and the third switch S3 and the fourth switch S4 are open, because both the second inductor L2 and the fourth inductor L4 are not coupled to the first inductor L1 and the third inductor L3, the loop in which the first transformer is located can operate normally. However, because the first switch S1 and the second switch S2 are closed, the first inductor L1 and the second inductor L2 are connected in parallel, and the second inductor L2 shunts a part of a current on the first inductor L1, so that the gain of the first transformer decreases.

As shown in FIG. 13c, when the first switch S1 and the second switch S2 are open, and the third switch S3 and the fourth switch S4 are closed, because both the second inductor L2 and the fourth inductor L4 are not coupled to the first inductor L1 and the third inductor L3, the loop in which the first transformer is located can operate normally. However, because the third switch S3 and the fourth switch S4 are closed, the third inductor L3 and the fourth inductor L4 are connected in parallel, and the fourth inductor L4 shunts a part of a current on the third inductor L3, so that the gain of the first transformer decreases.

As shown in FIG. 13d, when the first switch S1, the second switch S2, the third switch S3, and the fourth switch S4 are all closed, because both the second inductor L2 and the fourth inductor L4 are not coupled to the first inductor L1 and the third inductor L3, the loop in which the first transformer is located can operate normally. However, because the first switch S1 and the second switch S2 are closed, the first inductor L1 and the second inductor L2 are connected in parallel, and the second inductor L2 shunts a part of a current on the first inductor L1. The third switch S3 and the fourth switch S4 are closed, so that the third inductor L3 and the fourth inductor L4 are connected in parallel, and the fourth inductor L4 shunts a part of the current on the third inductor L3. Therefore, the gain of the first transformer is the smallest.

In some possible implementations, as shown in FIG. 3a to FIG. 3d, the first inductor L1 includes a first coil and a first lead, and the first coil is a loop having a first opening. An input end and an output end of the first coil are electrically connected to the first lead at the first opening.

The second inductor L2 includes a second coil and a third coil connected in series, and a second lead. The second coil has a second opening, and a magnetic field direction of the second coil is opposite to a magnetic field direction of the third coil. An input end and an output end of the second coil are electrically connected to the second lead at the second opening. The second coil and the third coil are nested in the first coil, and the first inductor L1 is not in direct contact with the second inductor L2.

It should be noted herein that the loop having the first opening refers to an unclosed geometric shape having a start point and an end point that are closely adjacent to each other and including at least one obvious convex part. In other words, a geometric shape having closed start point and end point and including at least one obvious convex part has the first opening.

For example, the loop includes one convex part. For example, as shown in FIG. 3a, the first coil may be an octagon with an opening on one side. For another example, as shown in FIG. 3b, the first coil may alternatively be a hexagon with an opening on one side. For another example, as shown in FIG. 3c, the first coil may alternatively be a circle having an opening.

For example, the loop includes two convex parts. For example, as shown in FIG. 3d, the first inductor L1 may be a spiral inductor, and the first coil may include two octagonal structures electrically connected to each other. One octagonal structure is closed, and one side of the other octagonal structure has an opening.

Certainly, the foregoing loop may be in another shape. This is not limited in embodiments of this application.

In some possible implementations, the second coil may include a first subloop and a first bent portion, and the third coil may include a second subloop and a second bent portion. The first bent portion and the second bent portion are configured to connect the first subloop and the second subloop. The first bent portion coincides with the second bent portion. The first subloop and the second subloop may be twisted through the first bent portion and the second bent portion, to form the second coil and the third coil that are connected in series.

Shapes of the first subloop and the second subloop may be closed geometric shapes that have a start point and an end point that are closely adjacent to each other and include at least one obvious convex part.

Optionally, as shown in FIG. 3a to FIG. 3c, the first subloop and the second subloop may be twisted through the first bent portion and the second bent portion, to form an 8-shaped shape.

For example, as shown in FIG. 3a and FIG. 3b, shapes of both the first subloop and the second subloop are polygons. For another example, as shown in FIG. 3c, shapes of both the first subloop and the second subloop are circles. Certainly, the first subloop and the second subloop may alternatively be in other shapes. This is not limited in embodiments of this application. The shape of the first subloop may be the same as or different from the shape of the second subloop.

In some possible implementations, the top of an 8-shape of the second coil may be an end part of a side that is of the first subloop and that is away from the second subloop.

Optionally, as shown in FIG. 3e, both the second coil and the third coil may be diamond-shaped.

Certainly, the second coil and the third coil may alternatively be of another shape. This is not limited in embodiments of this application.

In addition, a direction indicated by an arrow in FIG. 3a shows a direction of a current flowing through the second inductor L2 in a possible application scenario. A signal is sent to the second inductor L2 through one end of the second lead, and the second inductor L2 may generate magnetic flux. According to a right-hand rule, directions of magnetic flux in the first subloop and the second subloop are opposite.

In some possible implementations, a magnitude of magnetic flux in a first subloop is equal to a magnitude of magnetic flux in a second subloop, and magnetic flux flowing through the first subloop and magnetic flux flowing through the second subloop cancel with each other. Therefore, as shown in FIG. 5a, for the first coil nested outside the second coil and the third coil, a sum of magnetic flux on the second coil and the third coil is 0, and the second inductor L2 is not coupled to the first inductor L1.

In some other possible implementations, a magnitude of magnetic flux in a first subloop is not equal to a magnitude of magnetic flux in a second subloop, and magnetic flux flowing through the first subloop and magnetic flux flowing through the second subloop partially cancel with each other, to adapt to a required application scenario.

In some embodiments, when the magnitude of the magnetic flux in the first subloop is not equal to the magnitude of the magnetic flux in the second subloop, as shown in FIG. 5b the second inductor L2 may further include a fourth coil connected in series to the second coil and the third coil, and the fourth coil is nested in the first coil. A magnetic field direction of the fourth coil is the same as the magnetic field direction of the second coil. A magnitude of magnetic flux in the third coil is equal to a magnitude of magnetic flux in the second coil and in the fourth coil. Magnetic flux flowing through the third coil and magnetic flux flowing through the second coil and the fourth coil cancel with each other. Therefore, as shown in FIG. 5a, for the first coil nested outside the second coil, the third coil, and the fourth coil, a sum of magnetic flux in the second coil, in the third coil, and in the fourth coil is 0, and the second inductor L2 is not coupled to the first inductor L1.

Certainly, the magnitude of the magnetic flux in the third coil may alternatively be different from the magnitude of the magnetic flux in the second coil and in the fourth coil, to adapt to a required application scenario. The second inductor L2 may further include more coils that are connected in series to the second coil, the third coil, and the fourth coil. This is not limited in embodiments of this application.

In addition, when the second inductor L2 includes the second coil, the third coil, the fourth coil, or even more coils, for positions for disposing the first inductor L1 and the second inductor L2 in the chip, refer to the foregoing description that the second inductor L2 includes the second coil and the third coil. Fewer layers of conducting layers occupied by the first inductor L1 and the second inductor L2 are preferred.

As shown in FIG. 8a and FIG. 8b, the integrated circuit may further include a third inductor L3 and a fourth inductor L4. The third inductor L3 includes a fifth coil and a third lead, and the fifth coil is a loop having a third opening. An input end and an output end of the fifth coil are electrically connected to the third lead at the third opening.

The fourth inductor L4 includes a sixth coil and a seventh coil that are connected in series, and a fourth lead. The sixth coil has a fourth opening, and a magnetic field direction of the sixth coil is opposite to a magnetic field direction of the seventh coil. An input end and an output end of the sixth coil are electrically connected to the fourth lead at the fourth opening. The fifth coil is nested in the first coil, and the third coil, the fourth coil, the sixth coil, and the seventh coil are nested in the fifth coil. The first inductor L1, the second inductor L2, the third inductor L3, and the fourth inductor L4 are not in direct contact.

It should be noted herein that the loop having the third opening refers to an unclosed geometric shape having a start point and an end point that are closely adjacent to each other and including at least one obvious convex part. In other words, a geometric shape having closed start point and end point and including at least one obvious convex part has the third opening. A shape of the fifth coil may be the same as or different from a shape of the first coil, provided that the fifth coil is nested in the first coil.

In some possible implementations, the sixth coil may include a third subloop and a third bent portion, and the seventh coil may include a fourth subloop and a fourth bent portion. The third bent portion and the fourth bent portion are configured to connect the third subloop and the fourth subloop. The third bent portion coincides with the fourth bent portion. The third subloop and the fourth subloop may be twisted through the third bent portion and the fourth bent portion, to form the sixth coil and the seventh coil that are connected in series.

Shapes of the third subloop and the fourth subloop may be closed geometric shapes that have a start point and an end point that are closely adjacent to each other and include at least one obvious convex part. The shapes of the third subloop and the fourth subloop may be the same as or different from shapes of the first subloop and the second subloop. The shape of the third subloop may be the same as or different from the shape of the fourth subloop.

Optionally, the third subloop and the fourth subloop may be twisted through the third bent portion and the fourth bent portion, to form an 8-shaped shape. Alternatively, optionally, both the sixth coil and the seventh coil may be diamond-shaped. Certainly, the sixth coil and the seventh coil may alternatively be of another shape. This is not limited in embodiments of this application.

In some possible implementations, the top of an 8-shape of the fourth coil may be an end part of a side that is of the third subloop and that is away from the fourth subloop.

In some possible implementations, a relative position relationship between the second coil and the third coil and between the sixth coil and the seventh coil is not limited in this application, provided that the second coil, the third coil, the sixth coil, and the seventh coil are all nested in the fifth coil. As shown in FIG. 8a, orthographic projections of the second coil and the sixth coil on a substrate coincide, and orthographic projections of the third coil and the seventh coil on the substrate coincide. As shown in FIG. 8b, orthographic projections of the second coil and the sixth coil on the substrate are disposed in a staggered manner, and orthographic projections of the third coil and the seventh coil on the substrate are disposed in a staggered manner.

In some possible implementations, patterned conducting layers may further constitute the third inductor L3 and the fourth inductor L4 in this application, and the first inductor L1, the second inductor L2, the third inductor L3, and the fourth inductor L4 are not in direct contact. In addition, the fifth coil is nested in the first coil. The second coil, the third coil, the sixth coil, and the seventh coil are nested in the fifth coil, so that layout areas occupied by the second coil, the third coil, the fifth coil, the sixth coil, and the seventh coil can be omitted. In other words, a total area occupied by the first coil, the second coil, the third coil, the fifth coil, the sixth coil, and the seventh coil is an area occupied by the first coil. Therefore, the total area of the first inductor L1, the second inductor L2, the third inductor L3, and the fourth inductor L4 is reduced. In comparison with the case in which the two transformers are separately disposed, a total area of the two transformers including the first inductor L1 and the third inductor L3, and the second inductor L2 and the fourth inductor L4 may be reduced by about 50%, thereby reducing costs of the chip.

Specifically, as shown in FIG. 8b, when the second coil and the third coil are respectively staggered from the sixth coil and the seventh coil, so that the first bent portion and the second bent portion are staggered from the third bent portion and the fourth bent portion respectively, if the first lead does not coincide with the fourth lead, and the second lead does not coincide with the third lead, the first coil and the first lead of the first inductor L1, the second bent portion, the fifth coil, the third subloop, the fourth subloop, the fourth bent portion, and the fourth lead are disposed at a same layer. The first subloop, the second subloop, the first bent portion, the second lead, the third lead, and the third bent portion are disposed at a same layer. In addition, orthographic projections of the second coil, the third coil, the sixth coil, and the seventh coil on a substrate are located within a range of orthographic projections of the fifth coil on the substrate. An orthographic projection of the fifth coil on the substrate is located within a range of an orthographic projection of the first coil on the substrate. In this way, the first inductor L1, the second inductor L2, the third inductor L3, and the fourth inductor L4 can be implemented by using only two conducting layers.

A person skilled in the art should know that, under teachings of this application, other solutions in which the first inductor L1, the second inductor L2, the third inductor L3, and the fourth inductor L4 may be implemented by using two or more conducting layers all fall within the protection of this application.

Certainly, when the second coil coincides with the sixth coil, and the third coil coincides with the seventh coil, a first conducting layer and a second conducting layer may be added based on the foregoing two conducting layers. The first conducting layer includes a second bent portion, and the second conducting layer includes a third bent portion.

In addition, as shown in FIG. 8b, a signal is sent to the second inductor L2 through one end of the second lead, and the second inductor L2 may generate magnetic flux. According to a right-hand rule, directions of the magnetic flux in the third subloop and the fourth subloop are opposite.

In some possible implementations, a magnitude of magnetic flux in the third subloop is equal to a magnitude of magnetic flux in the fourth subloop, and magnetic flux flowing through the third subloop and the fourth subloop cancel with each other. Therefore, for the first coil and the fifth coil that are nested outside the sixth coil and the seventh coil, a sum of magnetic flux on the sixth coil and the seventh coil is 0, and the second inductor L2 is not coupled to the first inductor L1 and the third inductor L3.

In some other possible implementations, a magnitude of magnetic flux in the third subloop is not equal to a magnitude of magnetic flux in the fourth subloop, and magnetic flux flowing through the third subloop and magnetic flux flowing through the fourth subloop partially cancel with each other, to adapt to a required application scenario.

In some embodiments, when a magnitude of magnetic flux in the third subloop is not equal to a magnitude of magnetic flux in the fourth subloop, the second inductor L2 may further include an eighth coil connected in series to the sixth coil and the seventh coil, and the eighth coil is nested in the fifth coil. A magnetic field direction of the eighth coil is the same as a magnetic field direction of the sixth coil. A magnitude of magnetic flux in the seventh coil is equal to a magnitude of magnetic flux in the sixth coil and the eighth coil. Magnetic flux flowing through the seventh coil and magnetic flux flowing through the sixth coil and the eighth coil cancel with each other. Therefore, for the fifth coil and the first coil that are nested outside the sixth coil, the seventh coil, and the eighth coil, a sum of magnetic flux on the sixth coil, the seventh coil, and the eighth coil is 0, and the fourth inductor L4 is not coupled to the first inductor L1 and the third inductor L3.

Certainly, the magnitude of the magnetic flux in the seventh coil may alternatively be different from the magnitude of the magnetic flux in the sixth coil and the eighth coil, to adapt to a required application scenario. The fourth inductor L4 may further include more coils that are connected in series to the sixth coil, the seventh coil, and the eighth coil. This is not limited in embodiments of this application.

In addition, when the fourth inductor L4 includes the sixth coil, the seventh coil, the eighth coil, or even more coils, for positions for disposing the first inductor L1, the second inductor L2, the third inductor L3, and the fourth inductor L4 in the chip, refer to the foregoing description that the fourth inductor L4 includes the sixth coil and the seventh coil. Fewer layers of conducting layers occupied by the first inductor L1, the second inductor L2, the third inductor L3, and the fourth inductor L4 are preferred.

In addition, it should be noted that: The first inductor L1, the second inductor L2, the third inductor L3, and the fourth inductor L4 in embodiments of this application may be the first inductor L1, the second inductor L2, the third inductor L3, and the fourth inductor L4 described in any one of the foregoing embodiments. For explanations, descriptions, and beneficial effects thereof, refer to the explanations, descriptions, and beneficial effects of any one of the foregoing embodiments. Details are not described herein again.

The integrated circuit including at least one of the first switch S1, the second switch S2, the third switch S3, and the fourth switch S4, and the first inductor L1, the second inductor L2, the third inductor L3, and the fourth inductor L4 may be used in the dual-frequency amplifier and the single-frequency bidirectional amplifier.

FIG. 14 shows a circuit diagram of a dual-frequency amplifier, configured to transmit a signal in a 28 GHz frequency band and a signal in a 30 GHz frequency band. The first transformer may include a first sub-transformer and a third sub-transformer of the dual-frequency amplifier, and the second transformer may include a second sub-transformer and a fourth sub-transformer of the dual-frequency amplifier.

The dual-frequency amplifier includes a first amplifier 11, a second amplifier 12, the first sub-transformer, the second sub-transformer, the third sub-transformer, and the fourth sub-transformer. Input ends of the first amplifier 11 and the second amplifier 12 are electrically connected to the first sub-transformer and the second sub-transformer, and output ends of the first amplifier 11 and the second amplifier 12 are electrically connected to the third sub-transformer and the fourth sub-transformer. The first sub-transformer includes a first inductor L1 and a third inductor L3, the second sub-transformer includes a second inductor L2 and a fourth inductor L4, the third sub-transformer includes another first inductor L1 and another third inductor L3, and the fourth sub-transformer includes another second inductor L2 and another fourth inductor L4.

On this basis, as shown in FIG. 14, the dual-frequency amplifier may further include two first switches S1, two third switches S3, and two fourth switches S4. One first switch S1 is electrically connected between the first inductor L1 and the second inductor L2 on an input side, and the other first switch S1 is electrically connected between the first inductor L1 and the second inductor L2 on an output side. One third switch S3 and one fourth switch S4 are electrically connected between the third inductor L3 and the fourth inductor L4 on the input side respectively, and the other third switch S3 and the other fourth switch S4 are electrically connected between the third inductor L3 and the fourth inductor L4 on the output side respectively.

The following provides description by using an example in which a branch configured to transmit a 28 GHz frequency band operates and a branch configured to transmit a 39 GHz frequency band does not operate.

When the two first switches S1, the two third switches S3, and the two fourth switches S4 are all open, because both the second inductor L2 and the fourth inductor L4 are not coupled to the first inductor L1 and the third inductor L3, the branch configured to transmit the 28 GHz frequency band can operate normally, and the branch configured to transmit the 39 GHz frequency band does not affect the branch configured to transmit the 28 GHz frequency band. In this case, gains on both an input side and an output side of the branch configured to transmit the 28 GHz frequency band are the largest.

When the first switch S1 on the input side, the first switch S1, the third switch S3, and the fourth switch S4 on the output side are all open, and the third switch S3 and the fourth switch S4 on the input side are closed, because both the second inductor L2 and the fourth inductor L4 are not coupled to the first inductor L1 and the third inductor L3, the branch configured to transmit the 28 GHz frequency band can operate normally. In addition, because the third switch S3 and the fourth switch S4 on the input side are closed, the third inductor L3 and the fourth inductor L4 on the input side are connected in parallel. The fourth inductor L4 on the input side may shunt a part of the current on the third inductor L3, so that a gain on the input side of the branch configured to transmit the 28 GHz frequency band is reduced.

When the first switch S1 on the input side is closed, the third switch S3 and the fourth switch S4 on the input side, and the first switch S1, the third switch S3, and the fourth switch S4 on the output side are all open. Because both the second inductor L2 and the fourth inductor L4 are not coupled to the first inductor L1 and the third inductor L3, the branch configured to transmit the 28 GHz frequency band can operate normally. In addition, because the first switch S1 on the input side is closed, the first inductor L1 on the input side is connected in parallel to the second inductor L2. The second inductor L2 on the input side may shunt a part of the current on the first inductor L1, so that the gain on the input side of the branch configured to transmit the 28 GHz frequency band is reduced.

When the first switch S1 on the output side, the first switch S1, the third switch S3, and the fourth switch S4 on the input side are all open, and the third switch S3 and the fourth switch S4 on the output side are closed, because both the second inductor L2 and the fourth inductor L4 are not coupled to the first inductor L1 and the third inductor L3, the branch configured to transmit the 28 GHz frequency band can operate normally. In addition, because the third switch S3 and the fourth switch S4 on the output side are closed, the third inductor L3 on the output side and the fourth inductor L4 are connected in parallel. The fourth inductor L4 on the output side may shunt a part of the current on the third inductor L3, so that a gain on the output side of the branch configured to transmit the 28 GHz frequency band is reduced.

When the first switch S1 on the output side is closed, the third switch S3 and the fourth switch S4 on the output side, the first switch S1, the third switch S3, and the fourth switch S4 on the input side are all open, because both the second inductor L2 and the fourth inductor L4 are not coupled to the first inductor L1 and the third inductor L3, the branch configured to transmit the 28 GHz frequency band can operate normally. In addition, because the first switch S1 on the output side is closed, the first inductor L1 on the output side and the second inductor L2 are connected in parallel. The second inductor L2 on the input side may shunt a part of the current on the first inductor L1, so that the gain on the output side of the branch configured to transmit the 28 GHz frequency band is reduced.

When the two first switches S1, the two third switches S3, and the two fourth switches S4 are all closed, because both the second inductor L2 and the fourth inductor L4 are not coupled to the first inductor L1 and the third inductor L3, the branch configured to transmit the 28 GHz frequency band can operate properly. In addition, because the first switch S1 on the input side is closed, the first inductor L1 on the input side and the second inductor L2 are connected in parallel, and the second inductor L2 on the input side may shunt a part of the current on the first inductor L1. Because the third switch S3 and the fourth switch S4 on the input side are closed, the third inductor L3 on the input side and the fourth inductor L4 are connected in parallel. The fourth inductor L4 on the input side may shunt a part of the current on the third inductor L3, so that the gain on the input side of the branch configured to transmit the 28 GHz frequency band is the smallest. Because the first switch S1 on the output side is closed, the first inductor L1 on the output side and the second inductor L2 are connected in parallel, and the second inductor L2 on the output side may shunt a part of the current on the first inductor L1. Because the third switch S3 and the fourth switch S4 on the output side are closed, the third inductor L3 on the output side and the fourth inductor L4 are connected in parallel. The fourth inductor L4 on the output side may shunt a part of the current on the third inductor L3, so that the gain on the output side of the branch configured to transmit the 28 GHz frequency band is the smallest.

The foregoing example describes, by using an example, a case in which the branch configured to transmit the 28 GHz frequency band operates and a branch configured to transmit the 39 GHz frequency band does not operate. In addition, the branch configured to transmit the 28 GHz frequency band and the branch configured to transmit the 39 GHz frequency band may alternatively operate at the same time. In this case, gains of the branch configured to transmit the 28 GHz frequency band and the branch configured to transmit the 39 GHz frequency band are slightly less than a gain of the branch configured to transmit only the 28 GHz frequency band in a same case.

In embodiments of this application, in comparison with the dual-frequency amplifier shown in FIG. 2e, in this application, two first switches S1, two third switches S3, and two fourth switches S4 are added to adjust a gain of the dual-frequency amplifier, so that the dual-frequency amplifier does not need to rely on an active circuit to perform gain switching. This avoids increasing design costs and power consumption of the chip due to the active circuit. In addition, the first sub-transformer, the second sub-transformer, the third sub-transformer, and the fourth sub-transformer in this application may be further used to reduce layout areas occupied by four transformers T.

FIG. 15a to FIG. 15c show circuit diagrams of a single-frequency bidirectional amplifier. The foregoing first transformer may include a first sub-transformer and a third sub-transformer of the single-frequency bidirectional amplifier, and the foregoing second transformer may include a second sub-transformer and a fourth sub-transformer of the single-frequency bidirectional amplifier.

The single-frequency bidirectional amplifier further includes a first end P1, a second end P2, a third amplifier 13 and a fourth amplifier 14 that are inverted, a first sub-transformer, a second sub-transformer, a third sub-transformer, a fourth sub-transformer, two first inductors L1, two second inductors L2, a fifth switch K5, a sixth switch K6, a seventh switch K7, an eighth switch K8, two third switches S3, and two fourth switches S4.

The third amplifier 13 and the fourth amplifier 14 are electrically connected between the first end P1 and the second end P2. The first sub-transformer and the second sub-transformer are electrically connected between the first end P1, and the third amplifier 13 and the fourth amplifier 14. The third sub-transformer and the fourth sub-transformer are electrically connected between the second end P2, and the third amplifier 13 and the fourth amplifier 14. One end of the fifth switch K5 is electrically connected between the first end P1 and the first inductor L1 of the first sub-transformer, and the other end is grounded. One end of the sixth switch K6 is electrically connected between the first end P1 and the second inductor L2 of the second sub-transformer, and the other end is grounded. One end of the seventh switch K7 is electrically connected between the second end P2 and the first inductor L1 of the third sub-transformer, and the other end is grounded. One end of the eighth switch K8 is electrically connected between the second end P2 and the second inductor L2 of the fourth sub-transformer, and the other end is grounded. One first inductor L1 is electrically connected between the first end P1 and the fifth switch K5, and the other first inductor L1 is electrically connected between the second end P2 and the seventh switch K7. One second inductor L2 is electrically connected between the first end P1 and the sixth switch K6, and the other second inductor L2 is electrically connected between the second end P2 and the eighth switch K8. One third switch S3 and one fourth switch S4 are electrically connected between the third inductor L3 of the first sub-transformer and the fourth inductor L4 of the second sub-transformer, and the other third switch S3 and the other fourth switch S4 are electrically connected between the third inductor L3 of the third sub-transformer and the fourth inductor L4 of the fourth sub-transformer.

The first inductor L1 electrically connected between the first end P1 and the fifth switch K5 and the second inductor L2 electrically connected between the first end P1 and the sixth switch K6 are not coupled to each other. The first inductor L1 electrically connected between the second end P2 and the seventh switch K7 and the second inductor L2 electrically connected between the second end P2 and the eighth switch K8 are not coupled to each other. In addition, the two first inductors L1 may alternatively be the third inductor L3, and the two second inductors L2 may alternatively be the fourth inductor L4. This is not limited in embodiments of this application.

In some possible implementations, the single-frequency bidirectional amplifier may be controlled to operate by controlling the fifth switch K5, the sixth switch K6, the seventh switch K7, and the eighth switch K8 to be closed or open. The details are as follows.

As shown in FIG. 15b, when the fifth switch K5 and the eighth switch K8 are open, and the sixth switch K6 and the seventh switch K7 are closed, the first end P1 serves as an input end, the second end P2 serves as an output end, the first sub-transformer, the third amplifier 13, and the third sub-transformer operate, and the second sub-transformer, the fourth amplifier 14, and the fourth sub-transformer do not operate.

As shown in FIG. 15c, when the sixth switch K6 and the seventh switch K7 are open, and the fifth switch K5 and the eighth switch K8 are closed, the first end P1 serves as an output end, the second end P2 serves as an input end, the second sub-transformer, the fourth amplifier 14, and the fourth sub-transformer operate, the first sub-transformer, the third amplifier 13, and the third sub-transformer do not operate.

Same as the foregoing embodiment, in embodiments of this application, a gain of the single-frequency bidirectional amplifier may be adjusted by controlling the two third switches S3 and the two fourth switches S4 to be open or closed.

Refer to FIG. 15b. The following is described by using an example in which the first sub-transformer, the third amplifier 13, and the third sub-transformer operate, and the second sub-transformer, the fourth amplifier 14, and the fourth sub-transformer do not operate.

When the two third switches S3 and the two fourth switches S4 are both open, because the second inductor L2 and the fourth inductor L4 of the second sub-transformer and the fourth sub-transformer, are not coupled to the first inductor L1 and the third inductor L3 of the first sub-transformer and the third sub-transformer, the first sub-transformer and the third sub-transformer can operate normally. In addition, the second inductor L2 and the fourth inductor L4 of the second sub-transformer and the fourth sub-transformer are used, and the first inductor L1 and the third inductor L3 of the first sub-transformer and the third sub-transformer are not affected. In this case, gains of the first sub-transformer and the third sub-transformer are both the largest.

When the third switch S3 and the fourth switch S4 that are electrically connected between the first end P1 and the third amplifier 13 and the fourth amplifier 14 are closed, and the third switch S3 and the fourth switch S4 that are electrically connected between the second end P2 and the third amplifier 13 and the fourth amplifier 14 are open, because the second inductor L2 and the fourth inductor L4 of the second sub-transformer and the fourth sub-transformer are not coupled to the first inductor L1 and the third inductor L3 of the first sub-transformer and the third sub-transformer, the first sub-transformer and the third sub-transformer can operate normally. In addition, because the third switch S3 and the fourth switch S4 that are electrically connected between the first end P1 and the third amplifier 13 and the fourth amplifier 14 are closed, the fourth inductor L4 of the second sub-transformer and the third inductor L3 of the first sub-transformer are connected in parallel. The fourth inductor L4 of the second sub-transformer may shunt a part of a current on the third inductor L3 of the first sub-transformer, so that a gain of the first sub-transformer is reduced.

When the third switch S3 and the fourth switch S4 that are electrically connected between the first end P1 and the third amplifier 13 and the fourth amplifier 14 are open, and the third switch S3 and the fourth switch S4 that are electrically connected between the second end P2 and the third amplifier 13 and the fourth amplifier 14 are closed, because the second inductor L2 and the fourth inductor L4 of the second sub-transformer and the fourth sub-transformer are not coupled to the first inductor L1 and the third inductor L3 of the first sub-transformer and the third sub-transformer, the first sub-transformer and the third sub-transformer can operate normally. In addition, because the third switch S3 and the fourth switch S4 that are electrically connected between the second end P2 and the third amplifier 13 and the fourth amplifier 14 are closed, the fourth inductor L4 of the fourth sub-transformer and the third inductor L3 of the third sub-transformer are connected in parallel. The fourth inductor L4 of the fourth sub-transformer may shunt a part of the current on the third inductor L3 of the third sub-transformer, so that a gain of the third sub-transformer is reduced.

When the third switch S3 and the fourth switch S4 that are electrically connected between the first end P1 and the third amplifier 13 and the fourth amplifier 14 and the third switch S3 and the fourth switch S4 that are electrically connected between the second end P2 and the third amplifier 13 and the fourth amplifier 14 are all closed, because the second inductor L2 and the fourth inductor L4 of the second sub-transformer and the fourth sub-transformer are not coupled to the first inductor L1 and the third inductor L3 of the first sub-transformer and the third sub-transformer, the first sub-transformer and the third sub-transformer can operate normally. In addition, because the third switch S3 and the fourth switch S4 that are electrically connected between the first end P1 and the third amplifier 13 and the fourth amplifier 14 are closed, the fourth inductor L4 of the second sub-transformer and the third inductor L3 of the first sub-transformer are connected in parallel. The fourth inductor L4 of the second sub-transformer may shunt a part of a current on the third inductor L3 of the first sub-transformer, so that a gain of the first sub-transformer is reduced. Because the third switch S3 and the fourth switch S4 that are electrically connected between the second end P2 and the third amplifier 13 and the fourth amplifier 14 are closed, the fourth inductor L4 of the fourth sub-transformer and the third inductor L3 of the third sub-transformer are connected in parallel. The fourth inductor L4 of the fourth sub-transformer may shunt a part of the current on the third inductor L3 of the third sub-transformer, so that a gain of the third sub-transformer is reduced.

In embodiments of this application, in comparison with the single-frequency bidirectional amplifier shown in FIG. 2f, in this application, two third switches S3 and two fourth switches S4 are added to adjust a gain of the single-frequency bidirectional amplifier, so that the single-frequency bidirectional amplifier does not need to rely on an active circuit to perform gain switching. This avoids increasing design costs and power consumption of the chip due to the active circuit. In addition, the first sub-transformer, the second sub-transformer, the third sub-transformer, and the fourth sub-transformer in this application may be further used to reduce layout areas occupied by four transformers T. The two first inductors L1 and the two second inductors L2 are used to reduce layout areas occupied by four inductors L.

The foregoing describes embodiments of this application with reference to the accompanying drawings. However, this application is not limited to the foregoing specific implementations. The foregoing specific implementations are merely examples, but are not limitative. Inspired by this application, a person of ordinary skill in the art may further make modifications without departing from the purposes of this application and the protection scope of the claims, and all the modifications shall fall within the protection of this application.

What is claimed is:

1. An integrated circuit comprising a first inductor and a second inductor, wherein:
the first inductor comprises a first coil, and the first coil is a loop having a first opening;
the second inductor comprises a second coil and a third coil that are connected in series, the second coil has a second opening, and a magnetic field direction of the second coil is opposite to a magnetic field direction of the third coil; and
the second coil and the third coil are nested in the first coil, and the first inductor is not in direct contact with the second inductor.

2. The integrated circuit according to claim 1, wherein the second inductor further comprises a fourth coil connected in series to the second coil and the third coil, and a magnetic field direction of the fourth coil is the same as the magnetic field direction of the second coil; and
a magnitude of magnetic flux in the third coil is equal to a magnitude of magnetic flux in the second coil and in the fourth coil, and the fourth coil is nested in the first coil.

3. The integrated circuit according to claim 1, wherein a magnitude of magnetic flux in the third coil is equal to a magnitude of magnetic flux in the second coil.

4. The integrated circuit according to claim 2, wherein the integrated circuit further comprises a first input end, a first output end, and a second output end; and
the first inductor is electrically connected between the first input end and the first output end, and the second inductor is electrically connected between the first input end and the second output end.

5. The integrated circuit according to claim 4, wherein the integrated circuit further comprises a first switch and a second switch;
one end of the first switch is electrically connected between the first inductor and the first output end, and another end of the first switch is grounded; and
one end of the second switch is electrically connected between the second inductor and the second output end, and another end of the second switch is grounded.

6. The integrated circuit according to claim 2, wherein there are two first inductors and two second inductors, and the integrated circuit comprises a second input end, a third input end, a third output end, a fourth output end, a fifth output end, and a sixth output end;
one first inductor is electrically connected between the second input end and the third output end, and another first inductor is electrically connected between the second input end and the fifth output end; and
one second inductor is electrically connected between the third input end and the fourth output end, and another second inductor is electrically connected between the third input end and the sixth output end.

7. The integrated circuit according to claim 6, wherein the integrated circuit further comprises a third switch, a fourth switch, a fifth switch, and a sixth switch;
one end of the third switch is electrically connected between the one first inductor and the third output end, and another end of the third switch is grounded;
one end of the fourth switch is electrically connected between the one second inductor and the fourth output end, and another end of the fourth switch is grounded;
one end of the fifth switch is electrically connected between the other first inductor and the fifth output end, and another end of the fifth switch is grounded; and
one end of the sixth switch is electrically connected between the other second inductor and the sixth output end, and another end of the sixth switch is grounded.

8. The integrated circuit according to claim 2, wherein the integrated circuit further comprises a third inductor and a fourth inductor;
the third inductor comprises a fifth coil, and the fifth coil is a loop having a third opening;
the fourth inductor comprises a sixth coil and a seventh coil that are connected in series, the sixth coil has a fourth opening, and a magnetic field direction of the sixth coil is opposite to a magnetic field direction of the seventh coil; and
the fifth coil is nested in the first coil, the second coil, the third coil, the sixth coil, and the seventh coil are nested in the fifth coil, and the first inductor, the second inductor, the third inductor, and the fourth inductor are not in direct contact.

9. The integrated circuit according to claim 8, wherein the fourth inductor further comprises an eighth coil connected in series to the sixth coil and the seventh coil, and a magnetic field direction of the eighth coil is the same as the magnetic field direction of the sixth coil; and
a magnitude of magnetic flux in the seventh coil is equal to a magnitude of magnetic flux in the sixth coil and in the eighth coil, and the eighth coil is nested in the fifth coil.

10. The integrated circuit according to claim 8, wherein a magnitude of magnetic flux in the seventh coil is equal to a magnitude of magnetic flux in the sixth coil.

11. The integrated circuit according to claim 9, wherein the integrated circuit further comprises a fourth input end, a fifth input end, a seventh output end, an eighth output end, a ninth output end, and a tenth output end;
the first inductor is electrically connected between the fourth input end and the seventh output end;
the second inductor is electrically connected between the fifth input end and the eighth output end;
the third inductor is electrically connected between the fourth input end and the ninth output end; and
the fourth inductor is electrically connected between the fifth input end and the tenth output end.

12. The integrated circuit according to claim 11, wherein the integrated circuit further comprises a seventh switch and an eighth switch;
one end of the seventh switch is electrically connected between the first inductor and the seventh output end, and another end of the seventh switch is electrically connected between the second inductor and the eighth output end; and
one end of the eighth switch is electrically connected between the third inductor and the ninth output end, and another end of the eighth switch is electrically connected between the fourth inductor and the tenth output end.

13. The integrated circuit according to claim 9, wherein there are two first inductors, two second inductors, two third inductors, and two fourth inductors, the integrated circuit further comprises a sixth input end, a seventh input end, an eighth input end, a ninth input end, an eleventh output end, a twelfth output end, a thirteenth output end, a fourteenth output end, a fifteenth output end, a sixteenth output end, a seventeenth output end, and an eighteenth output end;
one first inductor is electrically connected between the sixth input end and the eleventh output end, and another first inductor is electrically connected between the sixth input end and the fifteenth output end;
one second inductor is electrically connected between the seventh input end and the twelfth output end, and another second inductor is electrically connected between the seventh input end and the sixteenth output end;
one third inductor is electrically connected between the eighth input end and the thirteenth output end, and another third inductor is electrically connected between the eighth input end and the seventeenth output end; and
one fourth inductor is electrically connected between the ninth input end and the fourteenth output end, and another fourth inductor is electrically connected between the ninth input end and the eighteenth output end.

14. The integrated circuit according to claim 13, wherein the integrated circuit further comprises a ninth switch, a tenth switch, an eleventh switch, and a twelfth switch;
one end of the ninth switch is electrically connected between the one first inductor and the eleventh output end, and another end of the ninth switch is electrically connected between the one third inductor and the thirteenth output end;
one end of the tenth switch is electrically connected between the one second inductor and the twelfth output end, and another end of the tenth switch is electrically connected between the one fourth inductor and the fourteenth output end;
one end of the eleventh switch is electrically connected between the other first inductor and the fifteenth output end, and another end of the eleventh switch is electrically connected between the other third inductor and the seventeenth output end; and
one end of the twelfth switch is electrically connected between the other second inductor and the sixteenth output end, and another end of the twelfth switch is electrically connected between the other fourth inductor and the eighteenth output end.

15. The integrated circuit according to claim 8, wherein the second coil comprises a first bent portion and a first subloop, the third coil comprises a second bent portion and a second subloop, the first bent portion coincides with the second bent portion, the first inductor further comprises a first lead electrically connected to the first coil at the first opening, and the second inductor further comprises a second lead electrically connected to the second coil at the second opening;
the first inductor and the second bent portion are disposed at a same layer, and the second lead, the first bent portion, the first subloop, and the second subloop are disposed at a same layer; and
either the first lead does not coincide with the second lead, and the first inductor, the second lead, the first bent portion, the first subloop, and the second subloop are disposed at a same layer; or
the first lead at least partially coincides with the second lead, the first inductor, the first bent portion, the first subloop, and the second subloop are disposed at a same layer, and the second bent portion and the second lead are disposed at a same layer.

16. The integrated circuit according to claim 15, wherein when the integrated circuit comprises the third inductor and the fourth inductor, the sixth coil comprises a third bent portion and a third subloop, the seventh coil comprises a fourth bent portion and a fourth subloop, the third bent portion coincides with the fourth bent portion, and the first bent portion and the second bent portion are respectively disposed in a staggered manner with the third bent portion and the fourth bent portion;
the third inductor further comprises a third lead electrically connected to the fifth coil at the third opening, and the fourth inductor further comprises a fourth lead electrically connected to the sixth coil at the fourth opening; and
the first lead does not coincide with the fourth lead, the second lead does not coincide with the third lead, the first inductor, the second bent portion, the fifth coil, the third subloop, the fourth subloop, the fourth bent portion, and the fourth lead are disposed at a same layer, and the first subloop, the second subloop, the first bent portion, the second lead, the third lead, and the third bent portion are disposed at a same layer.

17. An integrated circuit, comprising a first transformer, a second transformer, a first switch, a second switch, a third switch, and a fourth switch, wherein
the first transformer comprises a first inductor and a third inductor, the second transformer comprises a second inductor and a fourth inductor, the first inductor is connected in parallel to the second inductor through the first switch and the second switch, and the third inductor is connected in parallel to the fourth inductor through the third switch and the fourth switch.

18. The integrated circuit according to claim 17, wherein the first inductor comprises a first coil, and the first coil is a loop having a first opening;
the second inductor comprises a second coil and a third coil that are connected in series, the second coil has a second opening, and a magnetic field direction of the second coil is opposite to a magnetic field direction of the third coil;
the third inductor comprises a fifth coil, and the fifth coil is a loop having a third opening;
the fourth inductor comprises a sixth coil and a seventh coil that are connected in series, the sixth coil has a fourth opening, and a magnetic field direction of the sixth coil is opposite to a magnetic field direction of the seventh coil; and
the fifth coil is nested in the first coil, the second coil, the third coil, the sixth coil, and the seventh coil are nested in the fifth coil, and the first inductor, the second inductor, the third inductor, and the fourth inductor are not in direct contact.

19. The integrated circuit according to claim 18, wherein the second inductor further comprises a fourth coil connected in series to the second coil and the third coil, a magnetic field direction of the fourth coil is the same as the magnetic field direction of the second coil, a magnitude of magnetic flux in the third coil is equal to a magnitude of magnetic flux in the second coil and in the fourth coil, and the fourth coil is nested in the first coil; and
the fourth inductor further comprises an eighth coil connected in series to the sixth coil and the seventh coil, a magnetic field direction of the eighth coil is the same as the magnetic field direction of the sixth coil, a magnitude of magnetic flux in the seventh coil is equal to a magnitude of magnetic flux in the sixth coil and in the eighth coil, and the eighth coil is nested in the fifth coil.

20. A terminal, comprising an integrated circuit, the integrated circuit comprising a first inductor and a second inductor, wherein:
the first inductor comprises a first coil, and the first coil is a loop having a first opening;
the second inductor comprises a second coil and a third coil that are connected in series, the second coil has a second opening, and a magnetic field direction of the second coil is opposite to a magnetic field direction of the third coil; and
the second coil and the third coil are nested in the first coil, and the first inductor is not in direct contact with the second inductor.
